(19) United States
(12) Patent Application Publication
(10) Pub. No.: US 2024/0275729 A1
(43) Pub. Date: Aug. 15, 2024

(54) Wireline Communication Technique

(71) Applicant: Telefonaktiebolaget LM Ericsson (publ), Stockholm (DE)

(72) Inventors: Dhruvin Patel, Aachen (DE); Torsten Dudda, Wassenberg (DE); Kurt Essigmann, Aachen (DE)

(21) Appl. No.: 18/258,681

(22) PCT Filed: Dec. 30, 2020
(86) PCT No.: PCT/EP2020/088056

§ 371 Date: Jun. 21, 2023

(51) Int. Cl. H04L 47/2491; H04L 47/28

(52) U.S. Cl. CPC H04L 47/2491; H04L 47/28

(57) ABSTRACT

A technique for communicating protocol data units, PDUs, of a PDU session (702) through a wireline connection (506) between a residential gateway, RG (512), and a user plane function, UPF (522), of a core network, CN (720), of a radio communications system is described. The PDU session (702) extends between the UPF (522) and the RG (512) registered as a user equipment, UE (513), at the CN (720). As to a method aspect of the technique, one or more QoS parameters associated with at least one QoS flow (704) of the PDU session (702) are translated to one or more time-sensitive networking, TSN, attributes. The one or more TSN attributes are sent to an entity (502) for centralized user configuration, CUC, of a TSN domain (500) comprising the wireline connection (506) between the RG (512) and the UPF (522).

### TECHNICAL FIELD

The present disclosure relates to a technique for communicating through a wireline connection. More specifically, and without limitation, methods and devices are provided for communicating protocol data units (PDUs) of a PDU session through a wireline connection between a residential gateway and a core network of a radio communications system.

### BACKGROUND

In a radio communication system, radio devices communicate to a core network (CN) via a Radio Access Network (RAN), e.g., defined by the Third Generation Partnership Project (3GPP) or the Wi-Fi Alliance. The RAN covers a geographical area which is divided into service areas such as cells, which may also be referred to as a beams. A radio access node of the RAN, such as a 3GPP base station or a Wi-Fi access point, provides radio access, i.e. radio coverage, in at least one of the service areas. The radio access node communicates over a radio interface operating on radio frequencies with the radio devices within the service areas.

For deterministic data transport, the RAN can be embedded in a Time-Sensitive Networking (TSN) system. The document WO 2020/111995 A1 describes a technique for handling generalized Precise Timing Protocol (gPTP) signaling for TSN. A transmitting device receives a gPTP message from the TSN system. The gPTP message comprises time information and a time domain related to the time information. The transmitting device extracts the time information and the time domain from the gPTP message. The transmitting device transmits a 3GPP message to a receiving device. The 3GPP message comprises the time information and the time domain related to the time information.

For example, a sensor-UE functioning as a radio device (i.e., a wireless UE) may be connected to a 5G wireless machine programmable logic controller functioning as a wireless UE (PLC-UE). In such a case, the user data must traverse the RAN twice, namely from the sensor-UE to the CN and from the network to the PLC-UE. That causes duplicated delay, doubles the load to the RAN and reduces the reliability of the user data transmission.

Furthermore, the Third Generation Partnership Project (3GPP) defined wireline access for Fifth Generation User Equipments (5G UEs) in Release 16. That is, UEs may be radio devices connectable to the CN via the RAN or wireline devices connected to the CN via a wireline connection. To this end, a Wireline Access Gateway Function (W-AGF) terminates the N2 and N3 interfaces towards the CN. At the UE side, a 5G-aware 5G Residential Gateway (5G-RG) or a non-5G aware Fixed Network Residential Gateway (FN-RG) may be used. In the first case the 5G-RG acts as a 5G UE, terminating the N1 interface, while in the latter—the W-AGF has to take over the handling of the N1 interface.

While the 3GPP document TS 23.316, e.g., version 16.6.0, supports a uniform handling of the UE wireless access and UE wireline access, there is currently no way for TSN in such a coexistence of wireless and wireline accesses.

For example, the machine PLC is connected by wireline already, however it is currently impossible to connect wireless UEs as well as a wireline UE such as the machine PLC to the CN, while at the same time guaranteeing latency and/or reliability and determinism as required for industrial automation. It is noted that the alternative of connecting the wireline device outside the radio communication system (e.g., a 5G system) is disadvantageous, given that management of different systems becomes complex and that features of the radio communication system such as authentication, security, mobility procedures, application-specific Quality of Service (QoS), and/or traffic steering are unavailable used.

### SUMMARY

Accordingly, there is a need for a technique that enables a wireline connection to a radio communication system for time-sensitive networking (TSN). An alternative or more specific object is a coexistence of wireless access and wireline access for TSN.

As to a first method aspect, a method of communicating protocol data units (PDUs) of a PDU session through a wireline connection (e.g., a wireline communication) between a residential gateway (RG) and a user plane function (UPF) of a core network (CN) of a radio communications system is provided. The PDU session extends between the UPF and the RG registered as a user equipment (UE) at the CN. The method comprises or initiates a step of translating one or more QoS parameters associated with at least one QoS flow of the PDU session to one or more time-sensitive networking (TSN) attributes. The method further comprises or initiates a step of sending the one or more TSN attributes to an entity for centralized user configuration (CUC) of a TSN domain comprising the wireline connection between the RG and the UPF.

The RG may comprise, or may be embodied by, at least one of a Fifth Generation Residential Gateway (5G-RG), a Fixed Network RG (FN-RG), and a Wireline Access Gateway Function (W-AGF).

The RG may be connected to the UE (e.g., as a UE layer 3 and/or a UE application layer such as PLC) according to the Broadband Forum (BBF) or the Data Over Cable Service Interface Specification (DOCSIS).

The TSN domain may comprise at least one of the RG and the UPF. The one or more TSN attributes may be indicative of one or more TSN stream requirements of the RG or the UE for the PDU session, e.g., for each of the at least one QoS flow.

The entity for CUC may be referred to as the CUC entity. The TSN domain may be configured according to the sent one or more TSN attributes, e.g., by the CUC entity.

Since the RG is configured to register or registered as a UE at the CN, the RG may also be referred to as the UE.

The RG may be configured to register or may be registered at an access and mobility management function (AMF) of the CN.

The UE may need no physical layer (also referred to as PHY layer, layer 1, or L1) of a UE functioning as a radio device and/or no link layer (also referred to as data link layer, layer 2, or L2) of a UE functioning as a radio device. The RG may comprise functionality for the wireline connection (e.g., Ethernet functionality) on the physical layer and/or the link layer.

Alternatively or in addition, the link layer of the RG may be configured to perform the first method aspect.

Alternatively or in addition, the RG may comprise a layer 3 (also referred to as L3) of the UE and/or higher layers of the UE. For example, the RG may comprise a non-access stratum (NAS) layer (e.g., as a sublayer of L3), which may correspond to the NAS layer of the UE and/or which is configured to register the RG as a UE at the CN. As an alternative or further example, the RG may comprise a radio resource control (RRC) layer (e.g., as a sublayer of L3), which may correspond to the RRC layer of the UE and/or which may be configured to send and/or receive RRC signaling. The RRC signaling of the RG (e.g., the RRC signaling corresponding to the UE) may be included in and/or extracted from a link layer of the TSN domain.

For example, the RG may comprise higher layers (e.g., L3 and/or an application layer) corresponding to the UE. The RG may comprise lower layers (e.g., L1 and/or L2) that are different from those of the UE and/or that are configured for the wireline connection (e.g., for wireline access to the wireline connection) and/or configured to perform the first method aspect. Since the higher layers of the RG may correspond to the UE, the higher layers of the RG may be referred to as the UE.

The wireline connection may encompass any data connection, e.g., a point-to-point connection. The wireline connection may be a point-to-point connection and/or a multi-hop connection between the RG and the CN on the link layer. The wireline connection may comprise one or multiple physical media for the data connection between the RG and the CN. For example, on a physical layer, the wireline connection may comprise or may be embodied by at least one of twisted pairs of isolated wires, optical fiber cable, a coaxial cable (briefly: coax cable), a microwave link, and a laser light link. The physical media may be coupled along the point-to-point connection by means of one or more bridges or one or more switches of the TSN domain.

Embodiments of the method can route control and/or data traffic of the UE through the TSN domain to and/or from the UPF of the CN, e.g., without using radio resources of the radio communications system and/or without using a radio access network of the radio communications system as a TSN bridge. Same of further embodiments of the technique can enable a coexistence of wireline access for TSN (i.e., the wireline connection for TSN) and radio access for TSN (i.e., a wireless connection for TSN) within the radio communications system.

The method may further comprise or initiate a step of communicating the PDUs of the PDU session through the wireline connection between the RG and the CN.

The method may be performed by the RG or a RG TSN translator (RG-TT), e.g., connected to at least one of the RG and the UE. The RG-TT may be a node or unit or layer of the RG. Alternatively or in addition, the RG-TT may be embodied by a network protocol layer of a protocol stack (e.g., at the RG or the UE). The RG-TT may be embodied by the link layer, by a network protocol layer (e.g., directly) above the link layer in the protocol stack, and/or by a network protocol layer (e.g., directly) below the RRC layer in the protocol stack.

The RG-TT may comprise at least one of an ingress and an egress of the TSN domain.

The RG-TT may connect the UE to a link layer of the wireline connection and/or a link layer of the TSN domain. The link layer of the wireline connection and/or the TSN domain may also be referred to as a data link layer or Layer 2 (L2).

The method may further comprise or initiate a step of sending a TSN announcing message, from the RG-TT to the UE, e.g., responsive to connecting the UE with the RG-TT. The TSN attributes may be sent to the CUC entity responsive to a confirmation message received from the UE in response to the TSN announcing message.

The method may further comprise or initiate a step of receiving PDUs from the UE. The method may further comprise or initiate a step of sending the PDUs from the UE in frames of the link layer of the wireline connection and/or in TSN streams of the TSN domain between the RG and the CN. The TSN streams may be TSN flows.

The method may further comprise or initiate a step of receiving a TSN configuration from the CUC entity responsive to the sending of the one or more TSN attributes. The sending of the PDUs comprises mapping, according to the received TSN configuration, the PDUs from the UE into the frames and/or into the TSN streams.

The TSN configuration may be received in a TSN configuration message. The TSN configuration may be received at the RG or the RG-TT.

The method may further comprise or initiate a step of extracting the PDUs for the UE from frames of the link layer of the wireline connection and/or from the TSN streams of the TSN domain between the RG and the CN. The method may further comprise or initiate a step of sending the extracted PDUs to the UE.

The step of sending (e.g., including) the PDUs from the UE in the frames and/or in the TSN stream may comprise mapping the PDUs from the UE to frames of the link layer and/or to the TSN stream of the TSN domain between the RG and the CN. Alternatively or in addition, the step of extracting the PDUs for the UE from frames of the link layer and/or from the TSN streams may comprise mapping one or each of the frames of the link layer and/or one or each of the TSN streams of the TSN domain to the extracted PDUs for the UE.

The PDUs of the PDU session (also referred to as PDUs of the UE) may comprise PDUs from (e.g., originating from) the UE and/or PDUs for (e.g., addressed to) the UE.

The PDUs of the PDU session may comprise at least one of PDUs of a user plane of the UE and PDUs of a control plane of the UE. The one or more PDUs of the control plane of the UE may comprise radio resource control (RRC) signaling. Alternatively or in addition, the PDUs of the UE may comprise PDUs of a control plane of the UE and/or PDUs of a user plane of the UE. The PDUs of the control plane may comprise control signaling of a radio communications protocol and/or an RRC PDU, e.g., an RRC message or an RRC signal.

The frames of the link layer of the TSN domain or the wireline connection may comprise frames towards the UPF and/or frames towards the UE. Alternatively or in addition, the TSN streams may be unidirectional. A TSN stream towards the UPF may comprise the PDUs from the UPF, and/or another TSN stream towards the UE may comprise the PDUs for the UE.

The frames of the link layer and/or the TSN streams may comprise Ethernet frames. Alternatively or in addition, the TSN streams of different TSN attributes and/or the PDUs of different QoS flows may be mapped to different virtual LANs (VLANs) in the TSN domain.

The TSN domain may comprise at least one of: a wireline access network between the RG and the UPF; and an access gateway function (AGF) between the RG and the UPF.

The CUC may, e.g., by means of a centralized network controller (CNC), control a TSN configuration of the wireline access network and/or the AGF based on the TSN attributes. The wireline access network may comprise at least one bridge and/or switch for the wireline connection. Each of the at least one bridge and/or switch may be configured for TSN by the CNC.

The radio communications system may comprise a radio access network (RAN) connected to the UPF of the CN for providing radio access to a plurality of radio devices (also: wireless UEs) in the TSN domain.

The RAN may provide the radio access for TSN according to a TSN configuration of the CUC entity. The RAN and the wireline access network may be in the same TSN domain.

An application layer of the UE may comprise functionality of a programmable logic controller (PLC). The plurality of radio devices may comprise field devices or at least one of sensors and actuators. The PDUs to the PLC may be indicative of data from the sensors and/or the PDUs from the PLC may be indicative of control commands to the actuators.

Alternatively or in addition, a node or a unit embodying the application layer of the UE and the RG-TT may be collocated, e.g., in a switch box.

The UPF may be a PDU session anchor for both a PDU session extending between at least one of the radio devices over the RAN and the UPF of the CN and the PDU session extending between the UPF of the CN and the RG.

The plurality of radio devices may be registered as a plurality of further UEs at the same AMF of the CN at which the RG is registered as a UE.

The method may be triggered by establishing the PDU session. Alternatively or in addition, the one or more QoS parameters may be determined based on at least one of a request for establishing the PDU session from the RG and a confirmation of the QoS parameters from the UPF or the CN.

The request may be received from the RG registered as the UE. The request may be forwarded by the RG-TT from the UE or the RG to the CN (e.g., to the AMF). The request may be received from Layer 3 or from a non-access stratum layer (NAS layer) and sent (e.g., partially on the wireline connection) to the AMF. Alternatively or in addition, the confirmation of the QoS parameters may be received from the CN, the UPF or the AMF.

The one or more TSN attributes may be indicative of or may control requirements and/or rules for one or more TSN streams in which the PDUs are communicated through the wireline connection in the TSN domain. Alternatively or in addition, the one or more QoS parameters may be indicative of an ultra-reliable low-latency configuration (URLLC configuration) of the respective QoS flow.

The one or more QoS parameters may be indicative or may be based on at least one of a Packet Delay Budget (PDB); a QoS Class Identifiers (QCI); a limit on a delay of the PDUs; and a limit on a jitter of the PDUs.

The one or more QoS parameters may be provided by or may be based on a configuration of an application layer of the UE or the RG.

The radio communications system may comprise a radio access network (RAN). The RAN may provide radio access to the CN for a plurality of further UEs (also: radio devices). The QoS parameters may comprise the PDB that comprises a first part for the RAN and a second part for the wireline connection. The translating may be based on the second part. Optionally, the first part and the second part may sum up to the PDB.

The radio communications system may be a cellular communications system or radio telecommunications system. The RAN may provide the radio access for a plurality of further UEs, e.g., for TSN in the TSN domain according to a TSN configuration of the CUC entity.

Alternatively or in addition, the radio communications system may comprise a wireline access network. The wireline access network may provide the wireline access for the RG and/or the UE, e.g., for TSN according to a TSN configuration of the CUC entity.

The radio communications system may provide both the wireline access for TSN (i.e., the wireline connection to the CN for TSN) and the radio access for TSN (i.e., the wireless connection to the CN for TSN).

The method may further comprise or initiate a step of retaining a confirmation message indicative of the establishment of the PDU session from the CN until the TSN configuration is received from the CUC entity responsive to the sending of the one or more TSN attributes.

The one or more QoS parameters may be indicative of one or more rules for generating the TSN configuration at the CUC entity and/or the CNC entity.

The translating of the one or more QoS parameters to the one or more TSN attributes may be inverse (e.g., reverse) to a TSN translation rule for generating the TSN configuration applied to the PDU session.

As to a second method aspect, a method of communicating protocol data units (PDUs) of a PDU session through a wireline connection between a residential gateway (RG) and a user plane function (UPF) of a core network (CN) of a radio communications system is provided. The PDU session extends between the UPF and the RG registered as a user equipment (UE) at the CN. The method comprises or initiates a step of translating one or more QoS parameters associated with at least one QoS flow of the PDU session to one or more time-sensitive networking (TSN) attributes. The method further comprises or initiates a step of sending the one or more TSN attributes to an entity for centralized user configuration (CUC) of a TSN domain comprising the wireline connection between the RG and the UPF.

The second method aspect may be performed by a gateway TSN translator (GW-TT) at or connected to the UPF, the UPF, and/or any node of the CN.

The method may further comprise or initiate a step of receiving PDUs from the UPF. The method may further comprise or initiate a step of sending the PDUs from the UPF in frames of the link layer of the wireline connection and/or in TSN streams of the TSN domain between the RG and the CN.

The method may further comprise or initiate a step of receiving a TSN configuration from the CUC entity responsive to the sending of the one or more TSN attributes. The sending of the PDUs may comprise mapping, according to the received TSN configuration, the PDUs from the UE into the frames and/or into the TSN streams.

The method may further comprise or initiate a step of extracting the PDUs for the UPF from frames of the link layer of the wireline connection and/or from the TSN streams of the TSN domain between the RG and the CN. The method may further comprise or initiate a step of sending the extracted PDUs to the UPF.

The second method aspect may further comprise any feature and/or any step disclosed in the context of the first method aspect, or a feature and/or step corresponding thereto, e.g., a receiver counterpart to a transmitter feature or step.

Any aspect of the technique may be applied in the context of 3GPP New Radio (NR). Unlike 3GPP LTE, the wireline connection (i.e., the wireline access) according to 3GPP NR can provide a plurality of QoS flows, e.g., a wide range of QoS levels. Therefore, at least some embodiments of the technique can ensure that the TSN domain comprising the wireline connection fulfills the TSN attributes of the translated QoS parameters associated with the QoS flows of the PDU session.

The RAN of the radio communication system may implement any radio access technology (RAT), e.g., defined by the 3GPP or the Wi-Fi Alliance. The technique may be implemented in accordance with a 3GPP specification, e.g., for 3GPP release 16 or 17. The technique may be implemented for 3GPP LTE or 3GPP NR, e.g. according to a modification of the 3GPP document TS 23.316, version 16.6.0; the 3GPP document TS 23.501, version 16.7.0; and/or 3GPP document TS 24.501, version 17.1.0.

Any radio device may be a user equipment (UE), e.g., according to a 3GPP specification. The radio device and the RAN may be wirelessly connected in an uplink (UL) and/or a downlink (DL) through a Uu interface.

Any radio device as a wireless UE, the RAN, the RG as a wireline UE, the wireline access network, and/or the CN may form, or may be part of, the radio communication system, e.g., according to the Third Generation Partnership Project (3GPP) or according to the standard family IEEE 802.11 (Wi-Fi).

The RAN may comprise one or more radio access nodes (also referred to as base stations). Alternatively or in addition, the RAN may be a vehicular, ad hoc and/or mesh network comprising two or more radio devices, e.g., acting as a remote radio device and a relay radio device connecting the relay radio device to the RAN.

Any of the radio devices may be a 3GPP user equipment (UE) or a Wi-Fi station (STA). The radio device may be a mobile or portable station, a device for machine-type communication (MTC), a device for narrowband Internet of Things (NB-IoT) or a combination thereof. Examples for the UE and the mobile station include a mobile phone, a tablet computer and a self-driving vehicle. Examples for the portable station include a laptop computer and a television set. Examples for the MTC device or the NB-IoT device include robots, sensors and/or actuators, e.g., in manufacturing, automotive communication and home automation. The MTC device or the NB-IoT device may be implemented in a manufacturing plant, household appliances and consumer electronics.

Whenever referring to the RAN, the RAN may be implemented by one or more base stations. Any radio device may be wirelessly connected or connectable (e.g., according to a radio resource control, RRC, state or active mode) with the at least one base station of the RAN.

The base station may encompass any station that is configured to provide radio access to any of the radio devices. The base stations may also be referred to as cell, transmission and reception point (TRP), radio access node or access point (AP). The RAN and/or the wireline connection may provide a data link to a host computer providing user data in the PDUs or gathering user data from the PDUs. Examples for the base stations may include a 3G base station or Node B, 4G base station or eNodeB, a 5G base station or gNodeB, a Wi-Fi AP and a network controller (e.g., according to Bluetooth, ZigBee or Z-Wave).

The RAN may be implemented according to the Global System for Mobile Communications (GSM), the Universal Mobile Telecommunications System (UMTS), 3GPP Long Term Evolution (LTE) and/or 3GPP New Radio (NR).

Any aspect of the technique may be implemented on a Physical (PHY) layer, a Medium Access Control (MAC) layer, a Radio Link Control (RLC) layer, a packet data convergence protocol (PDCP) layer, and/or a Radio Resource Control (RRC) layer of a protocol stack for the radio communication (e.g., of the RAN). Alternatively or in addition, any aspect of the technique may be implemented on a PHY layer and/or a (e.g., data) link layer of a protocol stack for the wireline connection.

As to another aspect, a computer program product is provided. The computer program product comprises program code portions for performing any one of the steps of the first and/or second method aspect disclosed herein when the computer program product is executed by one or more computing devices. The computer program product may be stored on a computer-readable recording medium. The computer program product may also be provided for download, e.g., via the radio network, the RAN, the Internet and/or the host computer. Alternatively, or in addition, the method may be encoded in a Field-Programmable Gate Array (FPGA) and/or an Application-Specific Integrated Circuit (ASIC), or the functionality may be provided for download by means of a hardware description language.

As to a first device aspect, a residential gateway TSN translator (RG-TT) for communicating protocol data units (PDUs) of a PDU session through a wireline connection between a residential gateway (RG) and a user plane function (UPF) of a core network (CN) of a radio communications system is provided. The PDU session extends between the UPF and the RG registered as a user equipment (UE) at the CN. The RG-TT comprises memory operable to store instructions and processing circuitry operable to execute the instructions, such that the RG-TT is operable to translate one or more QoS parameters associated with at least one QoS flow of the PDU session to one or more time-sensitive networking (TSN) attributes; and to send the one or more TSN attributes to an entity for centralized user configuration (CUC) of a TSN domain comprising the wireline connection between the RG and the UPF.

The RG-TT may further be operable to perform any step of the first method aspect.

As to a further first device aspect, a residential gateway TSN translator (RG-TT) for communicating protocol data units (PDUs) of a PDU session through a wireline connection between a residential gateway (RG) and a user plane function (UPF) of a core network (CN) of a radio communications system is provided. The PDU session extends between the UPF and the RG registered as a user equipment (UE) at the CN. The RG-TT is configured to translate one or more QoS parameters associated with at least one QoS flow of the PDU session to one or more time-sensitive networking (TSN) attributes; and to send the one or more TSN attributes to an entity for centralized user configuration (CUC) of a TSN domain comprising the wireline connection between the RG and the UPF.

The RG-TT may further be configured to perform any step of the first method aspect.

As to a still further first device aspect, a user equipment (UE) or residential gateway (RG) for communicating protocol data units (PDUs) of a PDU session through a wireline connection between the RG and a user plane function (UPF) of a core network (CN) of a radio communications system is provided. The PDU session extends between the UPF and the RG registered as the UE at the CN. The UE or the RG comprising a wireline interface and processing circuitry configured to translate one or more QoS parameters associated with at least one QoS flow of the PDU session to one or more time-sensitive networking (TSN) attributes; and to send the one or more TSN attributes to an entity for centralized user configuration (CUC) of a TSN domain comprising the wireline connection between the RG and the UPF.

The processing circuitry may further be configured to execute any step of the first method aspect.

As to a second device aspect, a gateway TSN translator (GW-TT) for communicating protocol data units (PDUs) of a PDU session through a wireline connection between a residential gateway (RG) and a user plane function (UPF) of a core network (CN) of a radio communications system is provided. The PDU session extends between the UPF and the RG registered as a user equipment (UE) at the CN. The GW-TT comprises memory operable to store instructions and processing circuitry operable to execute the instructions, such that the GW-TT is operable to translate one or more QoS parameters associated with at least one QoS flow of the PDU session to one or more time-sensitive networking, TSN, attributes; and to send the one or more TSN attributes to an entity for centralized user configuration, CUC, of a TSN domain comprising the wireline connection between the RG and the UPF.

The GW-TT may further be operable to perform any step of the second method aspect.

As to a further second device aspect, a gateway TSN translator (GW-TT) for communicating protocol data units (PDUs) of a PDU session through a wireline connection between a residential gateway (RG) and a user plane function (UPF) of a core network (CN) of a radio communications system is provided. The PDU session extends between the UPF and the RG registered as a user equipment (UE) at the CN. The GW-TT is configured to translate one or more QoS parameters associated with at least one QoS flow of the PDU session to one or more time-sensitive networking, TSN, attributes; and to send the one or more TSN attributes to an entity for centralized user configuration, CUC, of a TSN domain comprising the wireline connection between the RG and the UPF.

The GW-TT may further be configured to perform any step of the second method aspect.

As to a still further second device aspect, a user plane function (UPF) for communicating protocol data units (PDUs) of a PDU session through a wireline connection between a residential gateway (RG) and the UPF of a core network (CN) of a radio communications system is provided. The PDU session extends between the UPF and the RG registered as the UE at the CN. The UPF comprising a wireline interface and processing circuitry configured to translate one or more QoS parameters associated with at least one QoS flow of the PDU session to one or more time-sensitive networking, TSN, attributes; and to send the one or more TSN attributes to an entity for centralized user configuration, CUC, of a TSN domain comprising the wireline connection between the RG and the UPF.

The UPF may further be configured to perform any step of the second method aspect.

As to a still further aspect, a communication system including a host computer is provided. The host computer comprises a processing circuitry configured to provide user data, e.g., included in the PDUs. The host computer further comprises a communication interface configured to forward the PDUs to a cellular network (e.g., the RAN and/or the wireline connection) for transmission to a UE (e.g., to the RG registered as a UE).

A processing circuitry of the cellular network may be configured to execute any one of the steps of the first and/or second method aspects. Alternatively or in addition, the RG or the UE comprises a wireline interface for the wireline connection and processing circuitry, which is configured to execute any one of the steps of the first and/or second method aspects.

The communication system may further include the UE. Alternatively, or in addition, the cellular network may further include one or more base stations configured for radio communication with the UE and/or to provide a data link between the UE and the host computer using the first and/or second method aspects.

The processing circuitry of the host computer may be configured to execute a host application, thereby providing the user data and/or any host computer functionality described herein. Alternatively, or in addition, the processing circuitry of the UE may be configured to execute a client application associated with the host application.

Any one of the devices, the RG, the UE, the RG-TT, the UPF, the GW-TT, the UPF, the CN, the radio communication system, the communication system or any node or station for embodying the technique may further include any feature disclosed in the context of the first and/or second method aspect, and vice versa. Particularly, any one of the units and modules disclosed herein may be configured to perform or initiate one or more of the steps of the first and/or second method aspect.

### BRIEF DESCRIPTION OF THE DRAWINGS

Further details of embodiments of the technique are described with reference to the enclosed drawings, wherein:

FIG. 1 shows a schematic block diagram of a UE-side or RG-side embodiment of a device for communicating PDUs of a PDU session through a wireline connection between a RG and a UPF of a radio communications system;

FIG. 2 shows a schematic block diagram of a network-side or UPF-side embodiment of a device for communicating PDUs of a PDU session through a wireline connection between a RG and a UPF of a radio communications system;

FIG. 3 shows a flowchart for UE-side or RG-side embodiment of a method of communicating PDUs of a PDU session through a wireline connection between a RG and a UPF of a radio communications system, which method may be implementable by the device of FIG. 1;

FIG. 4 shows a flowchart for network-side or UPF-side embodiment of a method of communicating PDUs of a PDU session through a wireline connection between a RG and a UPF of a radio communications system, which method may be implementable by the device of FIG. 2;

FIG. 5 schematically illustrates an embodiment of a TSN domain configured by a CUC entity, which may be usable in any embodiment of the devices of FIGS. 1 and 2;

FIG. 6 schematically illustrates a sequence chart resulting from an embodiment of the methods of FIGS. 3 and 4 for TSN configuration, which may use the CUC entity of FIG. 5;

FIG. 7 schematically illustrates an embodiment of a wireline connection for a radio communications system, which may comprise the devices of FIGS. 1 and 2;

FIG. 8 schematically illustrates embodiments of the methods of FIGS. 3 and 4 for establishment of a PDU session with TSN configuration;

FIG. 9 schematically illustrates an embodiment of a radio communications system comprising at least one cell comprising an embodiment of the device of FIG. 1.

FIG. 10 schematically illustrates an embodiment of a radio communications system for TSN in both wireless access and wireline access.

FIG. 11 shows a schematic block diagram of a residential gateway TSN translator embodying the device of FIG. 1;

FIG. 12 shows a schematic block diagram of a gateway TSN translator embodying the device of FIG. 2;

FIG. 13 schematically illustrates an example telecommunication network connected via an intermediate network to a host computer;

FIG. 14 shows a generalized block diagram of a host computer communicating via a base station or radio device functioning as a gateway with a user equipment over a partially wireless connection; and

FIGS. 15 and 16 show flowcharts for methods implemented in a communication system including a host computer, a base station and a user equipment.

### DETAILED DESCRIPTION

In the following description, for purposes of explanation and not limitation, specific details are set forth, such as a specific network environment in order to provide a thorough understanding of the technique disclosed herein. It will be apparent to one skilled in the art that the technique may be practiced in other embodiments that depart from these specific details. Moreover, while the following embodiments are primarily described for a New Radio (NR) or 5G implementation, it is readily apparent that the technique described herein may also be implemented for any other radio communication technique, including a Wireless Local Area Network (WLAN) implementation according to the standard family IEEE 802.11, 3GPP LTE (e.g., LTE-Advanced or a related radio access technique such as MulteFire), for Bluetooth according to the Bluetooth Special Interest Group (SIG), particularly Bluetooth Low Energy, Bluetooth Mesh Networking and Bluetooth broadcasting, for Z-Wave according to the Z-Wave Alliance or for ZigBee based on IEEE 802.15.4.

Moreover, those skilled in the art will appreciate that the functions, steps, units and modules explained herein may be implemented using software functioning in conjunction with a programmed microprocessor, an Application Specific Integrated Circuit (ASIC), a Field Programmable Gate Array (FPGA), a Digital Signal Processor (DSP) or a general purpose computer, e.g., including an Advanced RISC Machine (ARM). It will also be appreciated that, while the following embodiments are primarily described in context with methods and devices, the invention may also be embodied in a computer program product as well as in a system comprising at least one computer processor and memory coupled to the at least one processor, wherein the memory is encoded with one or more programs that may perform the functions and steps or implement the units and modules disclosed herein.

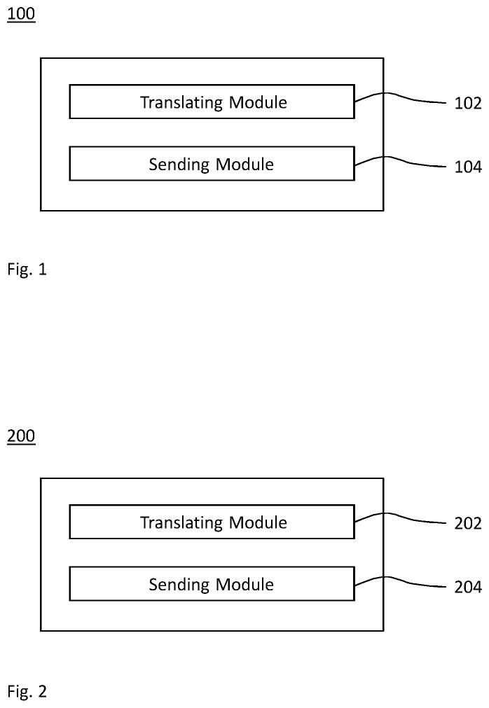

FIG. 1 schematically illustrates a block diagram of an embodiment of a device for communicating protocol data units (PDUs) of a PDU session through a wireline connection between a residential gateway (RG) and a user plane function (UPF) of a core network (CN) of a radio communications system. The PDU session extends between the UPF and the RG registered as a user equipment (UE) at the CN. The device is generically referred to by reference sign 100.

The device 100 comprises a translating module 102 that translates one or more QoS parameters associated with at least one QoS flow of the PDU session to one or more time-sensitive networking (TSN) attributes. The device 100 further comprises a sending module 104 that sends the one or more TSN attributes to an entity for centralized user configuration (CUC) of a TSN domain. The TSN comprises the wireline connection between the RG and the UPF.

Any of the modules of the device 100 may be implemented by units configured to provide the corresponding functionality.

The device 100 may also be referred to as, or may be embodied by, the UE, the RG or a TSN translator at the UE or at the RG (briefly: RG-TT). The RG-TT 100 and a TSN translator at the UPF may be in the wireline connection, e.g., at least for the TSN.

FIG. 2 schematically illustrates a block diagram of an embodiment of a device for communicating protocol data units (PDUs) of a PDU session through a wireline connection between a residential gateway (RG) and a user plane function (UPF) of a core network (CN) of a radio communications system. The PDU session extends between the UPF and the RG registered as a user equipment (UE) at the CN. The device is generically referred to by reference sign 200.

The device 200 comprises a translating module 202 that translates one or more QoS parameters associated with at least one QoS flow of the PDU session to one or more time-sensitive networking (TSN) attributes. The device 200 further comprises a sending module 204 that sends the one or more TSN attributes to an entity for centralized user configuration (CUC) of a TSN domain. The TSN comprises the wireline connection between the RG and the UPF.

Any of the modules of the device 200 may be implemented by units configured to provide the corresponding functionality.

The device 200 may also be referred to as, or may be embodied by, the CN, the UPF or a TSN translator at the CN or at the UPF (briefly: GW-TT or NW-TT). The GW-TT 200 and a TSN translator at the RG or UE may be in the wireline connection, e.g., at least for the TSN.

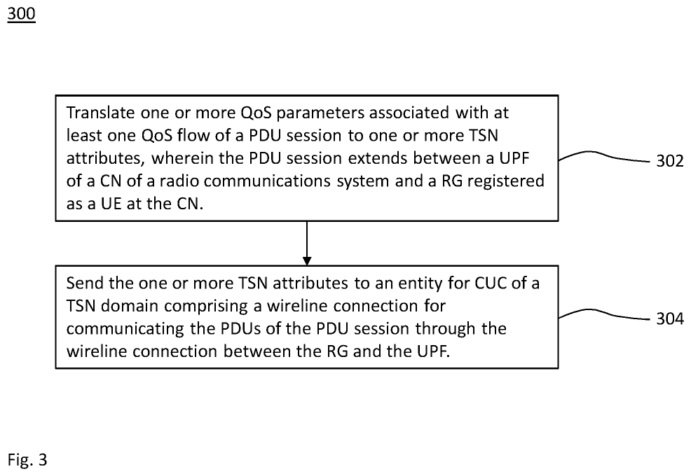

FIG. 3 shows a flowchart for an embodiment of a method 300 of communicating protocol data units (PDUs) of a PDU session through a wireline connection between a residential gateway (RG) and a user plane function (UPF) of a core network (CN) of a radio communications system. The PDU session extends between the UPF and the RG registered as a user equipment (UE) at the CN. The method 300 comprises a step 302 of translating (e.g., converting) one or more QoS parameters associated with at least one QoS flow of the PDU session to one or more time-sensitive networking (TSN) attributes (e.g., for defining a TSN configuration). The method 300 further comprises a step 304 of sending the one or more TSN attributes to an entity for centralized user configuration (CUC) of a TSN domain comprising the wireline connection between the RG and the UPF.

The method 300 may be performed by the RG-TT 100. For example, the modules 102 and 104 may perform the steps 302 and 304, respectively.

The RG-TT 100 may connect a wireline UE (or the RG comprising the wireline UE functionality) to a L2 TSN network (e.g., instead of a wireless connection to the RAN as provided by a conventional TSN translator for a wireless UE, UE-TT). The method 300 in the RG-TT 100 may translate QoS parameters (e.g., URLLC 5G1 parameters) into TSN attributes in the step 302 and may communicate these TSN attributes to a CUC entity (e.g., a CUC node) in the step 304.

The method 300 may map at least one of UE control plane messages (e.g., RRC messages) and UE data plane messages into Ethernet frames of the wireline connection, e.g., in a step of sending the PDUs of the PDU session. Alternatively or in addition, the method 300 may extract at least one of UE control plane messages (e.g., RRC messages) and UE data plane messages from Ethernet frames of the wireline connection and sends them to the UE or the RG, e.g., in a step of receiving the PDUs of the PDU session.

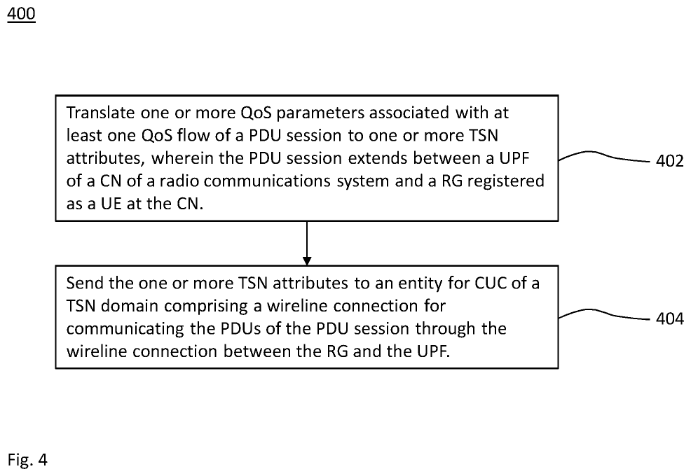

FIG. 4 shows a flowchart for an embodiment of a method 400 of communicating protocol data units (PDUs) of a PDU session through a wireline connection between a residential gateway (RG) and a user plane function (UPF) of a core network (CN) of a radio communications system. The PDU session extends between the UPF and the RG registered as a user equipment (UE) at the CN. The method 400 comprises a step 402 of translating (e.g., converting) one or more QoS parameters associated with at least one QoS flow of the PDU session to one or more time-sensitive networking (TSN) attributes (e.g., for defining a TSN configuration). The method 400 further comprises a step 404 of sending the one or more TSN attributes to an entity for centralized user configuration (CUC) of a TSN domain comprising the wireline connection between the RG and the UPF.

The method 400 may be performed by the GW-TT 200. For example, the modules 202 and 204 may perform the steps 402 and 404, respectively.

The GW-TT 200 may connect the CN or the UPF to a L2 TSN network (e.g., instead of a RAN for wireless connection to the UE). The method 400 in the GW-TT 200 may translate QoS parameters (e.g., URLLC 5G1 parameters) into TSN attributes in the step 402 and may communicate these TSN attributes to the CUC entity (e.g., a CUC node) in the step 404.

The method 400 may map user plane messages (e.g., from the UPF) into Ethernet frames of the wireline connection, e.g., in a step of sending the PDUs of the PDU session. Alternatively or in addition, the method 400 may extract a user plane messages (e.g., for the UPF) from Ethernet frames of the wireline connection and sends them to the UPF or the RG, e.g., in a step of receiving the PDUs of the PDU session.

In any aspect, a radio device may be a mobile or portable station and/or any radio device wirelessly connectable to a base station or RAN, or to another radio device. For example, the radio device may be a user equipment (UE), e.g. if wirelessly connected to the radio communications system. Alternatively or in addition, e.g. if in wireline connection through the RG with the UPF, the UE may be a device for machine-type communication (MTC) or a device for (e.g., narrowband) Internet of Things (IoT). For example, the UE may be a PLC and/or the RG.

Two or more radio devices may be configured to wirelessly connect to each other, e.g., in an ad hoc radio network or via a 3GPP sidelink (i.e. device-to-device) connection. Furthermore, any base station may be a station providing radio access, may be part of a radio access network (RAN) and/or may be a node connected to the RAN for controlling the radio access. For example, the base station may be an access point, for example a Wi-Fi access point.

In any embodiment, the UE connected through the wireline connection to the UPF may be a Programable Logic Controller (PLC), e.g., a machine PLC or manufacturing PLC. Conventionally, industrial sensors and actuators are connected to the PLC by wires. Some use cases require the sensors or actuators to move or to rotate, e.g., in an autonomously working robot or for transporting goods. Because of the motion or rotation, the sensors or actuators need to be connected wirelessly to the PLC. PLCs are connected to a line PLC or to a Supervisory Control and Data Acquisition (SCADA) systems usually via industrial Ethernet networks or TSN-enabled networks.

When a sensor, an actuator or the PLC must be connected wirelessly, they are each co-located with a radio device (i.e., a UE for radio access) that manages the radio communication, optionally including 3GPP-grade of authentication and data encryption. That radio communication is both secure and guarantees a predictable degree or grade of service, e.g., in terms of at least one of latency, reliability, and bandwidth.

TSN is based on the IEEE 802.3 Ethernet standard, and so is wired communication, while the RAN involves a RAT, e.g., a 5G or 4G wireless radio communication using Long Term Evolution (LTE) and/or New Radio (NR). TSN describes a collection of TSN features, for e.g. time synchronization, guaranteed low-latency transmissions and high reliability to make legacy Ethernet, designed for best-effort communication, deterministic. The TSN domain may comprise TSN features out of at least one of the following categories. A first category comprises Time Synchronization, e.g. according to IEEE 802.1AS. A second category comprises Bounded Low Latency, e.g. according to IEEE 802.1Qav, IEEE 802.1Qbu, IEEE 802.1Qbv, IEEE 802.1Qch, and/or IEEE 802.1Qcr. A third category comprises Ultra-Reliability, e.g. according to IEEE 802.1CB, IEEE 802.1Qca, and/or IEEE 802.1Qci. A fourth category comprises Network Configuration and Management, e.g. according to IEEE 802.1Qat, IEEE 802.1Qcc, IEEE 802.1Qcp, and/or IEEE 802.1CS.

The TSN attributes may requires and/or define at least one of the TSN features.

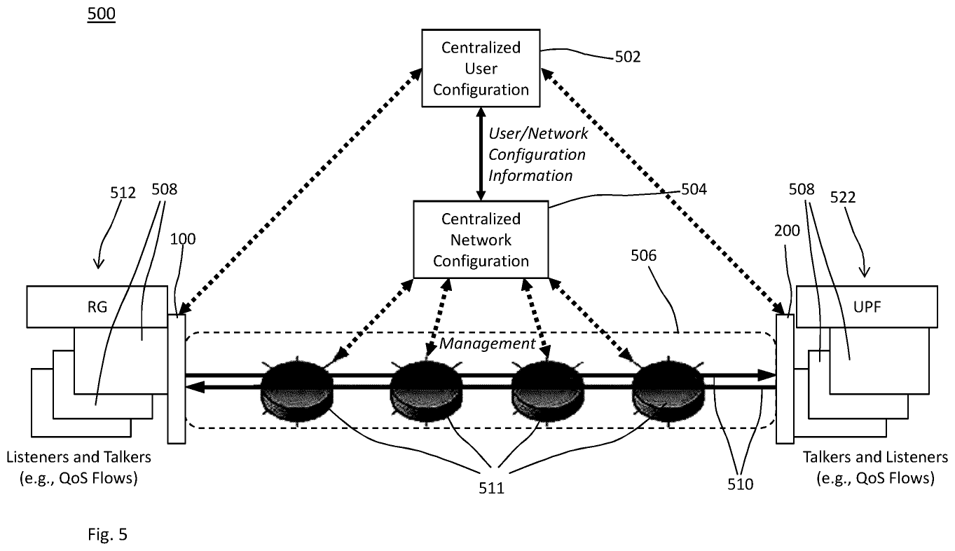

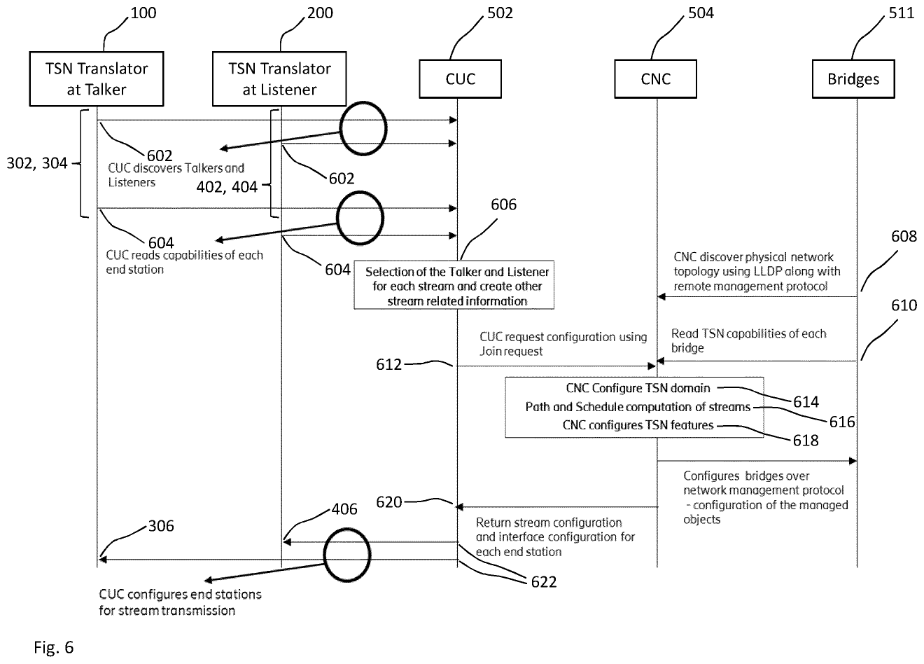

The CUC entity may configure and/or (e.g., indirectly) management the TSN domain. The configuration and/or management of the TSN domain can be implemented in different manners, e.g. centralized as schematically illustrated in FIG. 5. The TSN domain 500 may be controlled by the CUC entity 502, e.g., through a centralized network configuration (CNC) entity 504.

Alternatively or in addition, the TSN domain 500 may be centrally configuration according to the family 802 of IEEE specifications, e.g., IEEE 802.1CF and/or IEEE 802.1CS, and/or using the Stream Reservation Protocol (SRP) according to IEEE 802.1Qcc.

The device 100 may be implemented by a RG-TT. The device 200 may be implemented by a GW-TT.

A UE functionality of the RG 512 comprises a field device, e.g., as an application layer of the UE or RG 512. The field device may comprise at least one of a sensor, a actuator, and/or a PLC reading the sensors and/or controlling the actuators. The field device, the UE or the RG 512 is connected by means of the RG-TT 100 through the wireline connection 506 to the UPF 522 of the CN.

At the CN, the UPF 522 is connected by means of the GW-TT 200 through the wireline connection 506 to the RG 512, which is registered at the CN as the UE.

Within the TSN domain 500, the communication endpoints are called talker 508 and listener. There may be one talker 508 and one listener 508 for each QoS flow of the PDU session between the RG 512 and the UPF 522.

The wireline connection 506 enables one or more unidirectional TSN streams 510. There may be two TSN streams 510 in opposite directions for each QoS flow.

All the bridges 511 (which TSN terminology comprises switches and nodes) of the wireline connection 506 (i.e., in between talker 508 and listener 508) support certain TSN features such as time synchronization, e.g., according to IEEE 802.1AS. All nodes that are synchronized in a network belong to the so-called TSN domain 500. TSN communication is only possible within the TSN domain 500.

The communication between talker 508 and listener 508 happens in TSN streams 510. Each TSN stream 510 is based on certain requirements in terms of data rate and/or latency given by an application (e.g., the PLC) implemented at talker 508 and listener 508. The TSN features of the configuration and management (i.e., the entities 502 and 504) are used to setup the TSN stream 510 and guarantee the requirements of the TSN stream 510 across the TSN domain 500.

In the centralized model schematically illustrated in FIG. 5, the talker 508 and listener 508 may use a Stream Reservation Protocol (SRP) to setup and configure a TSN stream 510 in every switch 511 along the wireline connection 506 between the RG 512 and the UPF 522 (i.e., from talker 508 to listener 508) in the TSN domain 500.

Nevertheless, some TSN features require a central management entity called Centralized Network Configuration (CNC) entity 504 as schematically shown in FIG. 5. The CNC entity 504 uses for example Netconf and YANG models to configure the switches 511 in the wireline connection 506 for each TSN stream 510. This also allows the use of time-gated queueing, e.g., as defined in IEEE 802.1Qbv, which can enable data transport in the TSN domain 500 with deterministic latency. With time-gated queueing on each switch 511, queues are opened or closed following a precise schedule that allows high priority PDU to pass through the switch 511 with minimum latency and jitter if the PDU arrives at an ingress port within the time the gate is scheduled to be open.

In the fully centralized model, also the CUC entity is used as a point of contact for the devices 100 and 200 (e.g., more specifically, for the listener 508 and talker 508). The CUC entity 502 receives (e.g., collects) the TSN attributes as stream requirements and/or endpoint capabilities from the device 100 and/or the device 200. The CUC entity 502 may communicate with the CNC entity 504 directly to configure the TSN domain 500 comprising the wireline connection 506 according to the TSN attributes. The TSN configuration may be implemented as explained in IEEE 802.1Qcc.

FIG. 6 shows a sequence chart of an embodiment of the method 300 and/or the method 400 for TSN stream configuration using a centralized configuration of the TSN domain 500, e.g., as schematically shown in FIG. 5 Fehler! Verweisquelle konnte nicht gefunden werden. The roles of listener and talker may be interchanged in FIG. 6.

The method 300 and/or the method 400 may comprise at least one of the following setup steps to setup an TSN stream 510 in the TSN domain 500 using the (e.g., fully) centralized configuration.

A first setup step 602 comprises the CUC entity 502 receiving in the step 304 and/or 404 TSN attributes as input from the RG 512 and/or the UPF 522, respectively. The RG 512 may comprise, e.g., as the UE functionality on the application layer, an industrial application and/or an engineering tool (e.g., a PLC), which specifies the devices 100 and 200 which are supposed to exchange time-sensitive streams, i.e., TSN streams 510.

A second setup step 604 comprises the CUC entity 502 receiving in the step 304 and/or 404 (e.g., reading) as the TSN attributes the capabilities of the RG 512 and UPF 522 as the end stations and applications in the TSN domain 500.

The TSN attributes may comprise at least one of a period of user traffic in the PDU session, an interval of user traffic in the PDU session, and payload sizes in the PDUs in the PDU session.

A third setup step 606 comprises the CUC entity 504 creating, based on the received TSN attributes at least one of the following items. A first item comprises a Stream ID (or “StreamID”) as an identifier for each TSN stream 510. A second item comprises a Stream Rank (or “StreamRank”) for each TSN stream 510. A third item comprises User-to-Network Requirements (or “UsertoNetwork Requirements”).

A fourth setup step 608 comprises the CNC discovering a physical network topology of the wireline connection 506, e.g., using a Link Layer Discovery Protocol (LLDP) and/or any network management protocol, e.g., according to IEEE 802.1AB optionally with additional support in IEEE 802.3 section 6 clause 79.

A fifth setup step 610 comprises the CNC entity 504 using a network management protocol to read TSN capabilities of bridges 511 in the wireline connection 506, e.g., according to at least one of IEEE 802.1Q, 802.1AS, and 802.1CB, in the TSN domain 500.

A sixth setup step at reference sign 612 comprises the CUC entity 502 initiating join requests to configure the TSN streams 510 in order to configure network resources at the bridges 511 for each TSN stream 510 from one talker 508 to one listener 508.

A seventh setup step at reference sign 612 comprises creating groups of talkers 508 and listener 508 (e.g., a group of elements specifying a TSN stream 510) by the CUC entity, e.g., as specified in IEEE 802.1Qcc, 46.2.2.

A eighth setup step at reference sign 614 comprises the CNC entity 604 configuring the TSN domain 500.

A ninth setup step at reference sign 614 comprises the CNC entity 604 checking physical topology and checks if the time sensitive streams are supported by bridges in the network.

A tenth setup step 616 comprises the CNC entity 504 performing path and schedule computation of the TSN streams 510.

An eleventh setup step 618 comprises the CNC entity 504 configuring the TSN features in the bridges 511 along the wireline connection 506 in the TSN network.

This can be a configuration of the transmission schedule, e.g. explained below.

An twelfth setup step 620 comprises the CNC entity 504 returning a status (e.g., success or failure) for resulting resource assignment for the TSN streams 510 to the CUC entity 502. Furthermore, the bridges 511 are configured.

An thirteenth setup step 622 comprises the CUC entity 504 configuring the device 100 and 200 as TSN end stations in steps 306 and 406 of the methods 300 and 400, respectively. This protocol used for this information exchange may be out of the scope of the IEEE 802.1Qcc specification. Responsive to the TSN configuration from the CUC entity 502, a user plane traffic exchange may start as defined initially between the devices 100 and 200 (e.g., as listener 508 and talker 508).

In the TSN domain 500, the stream identifier (ID) is used to uniquely identify stream configurations. The stream ID is used to assign TSN resources to a TSN stream 510 of a user (e.g., the device 100 or 200). The stream ID comprises the two tuples of
(i) a MAC address associated with the TSN talker (e.g., the device 100 or 200) and
(ii) a unique identifier (ID) to distinguish between multiple TSN streams 510 within end stations 100 and 200 identified by the Mac Address.

In the centralized model as depicted in FIG. 5 the talker 508 is responsible for stream initialization. Alternatively or in addition, the bridges 511 are configured by the CNC entity 504 (e.g., as a means of the CUC entity 502).

The wireline connection 506 may be implemented using wireline access according to the 3GPP. For example, the radio communication system may be a 5G system supporting wireline access into the 5G CN through a 5G Resident Gateway (5G RG) as the RG 512, e.g., as specified in 3GPP document TS 23.501, version 16.7.0.

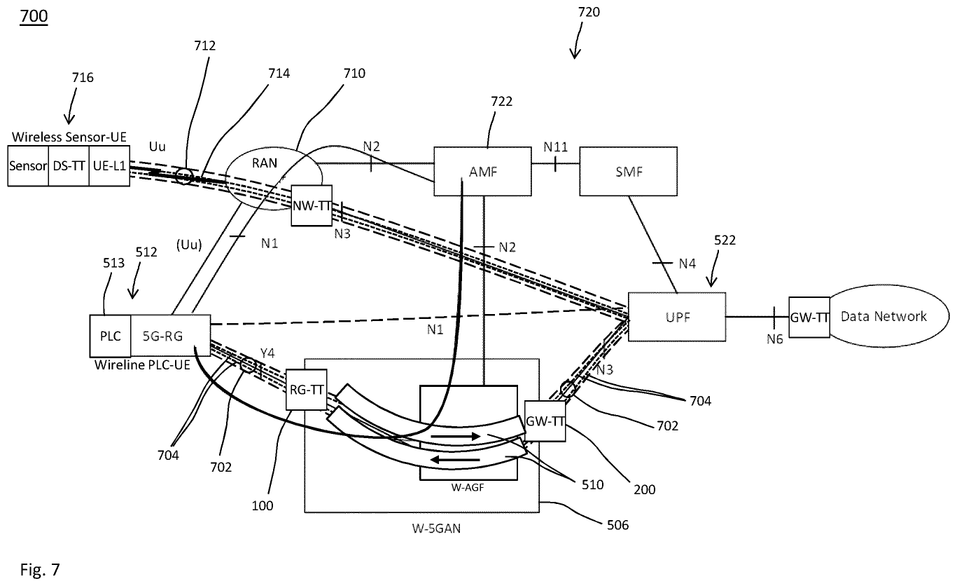

FIG. 7 schematically illustrates a wireline architecture for a radio communications system 700, e.g., a 5G system (5GS). A wireline architecture used for embodying the technique may be based on the 3GPP document TS 23.316, version 16.6.0, or an extension thereof.

The RG 512 may be a 5G RG. The RG 512 may be configured for wireline access to the wireline connection 506. For example, a Y4 interface (e.g., a 3GPP reference point) and/or the wireline 5G access network (W-5GAN) may function as the wireline connection 506, e.g., as schematically shown in FIG. 7. The wireline connection 506 may provide wireline access to a Wireline Access Gateway Function (W-AGF) and/or the UPF 522. Optionally, the RG 512 is further configured for wireless access to the RAN 710 (i.e., over a Uu interface).

Alternatively or in addition, the RG 512 (e.g., the 5G RG) is configured to setup a PDU session 702 and/or to register as a UE 513 (e.g., the 5G UE and/or layer 3 functionality of the 5G UE). The RG 512 can be possessed with QoS flows 704 to support a broad range of the services (e.g., different QoS) over the wireline connection 506.

Optionally, Network Slicing is applied across the wireline connection 506 (e.g., across the W-5GAN).

The field devices read by the PCL 513 (e.g., sensors) and/or the field devices controlled by the PCL 513 (e.g., actuators) may be radio devices 716 in wireless connection to the RAN 710. At least on or each of the radio devices 716 may provide the PDUs to the UPF 522 in a PDU session 712 comprising multiple QoS flows 714. Each radio device 716 may be registered as a further UE at an Access and Mobility Management Function (AMF) 722 of the CN 720. Each QoS flow 714 of the PDU session 712 between the respective radio device 716 and the UPF 522 may be forwarded and/or mapped (e.g., by the UPF 522) to a QoS flow 704 of the PDU session 702, and/or each QoS flow 704 of the PDU session 702 may be forwarded and/or mapped (e.g., by the UPF 522) to a QoS flow 714 of the PDU session 712.

More specifically, sensor functionality or actuator functionality of the field devices may be implemented by the application layer of the respective further UE. Alternatively or in addition, PLC functionality may be implemented by the application layer of the UE 513 embodied by or connected to the RG 512.

The W-AGF is a gateway providing both signaling and user plane connectivity from the RG-TT 100 through the wireline access network as the wireless connection 506 to the 5G CN 720. Since a network operator of the 5GS 700 may control both the wireless connection 506 and the 5G CN 720, a W-AGF in the wireline access network 506 is considered trusted and is authenticated by functions of the 5G CN 720 such as AMF or a “SEcurity Anchor Function” (SEAF) by establishing mutually authenticated Transport Layer Security (TLS) with the CN 720. This may require the W-AGF to be provisioned with server public key certificates for the authentication.

The devices 100 and 200 may be added to a 5GS 700, e.g., as schematically illustrated in FIG. 7 based on Figure 4.2.8.4-1 in the 3GPP document TS 23.501, version 16.7.0.

In any embodiment of the devices 100 and 200, the PLC 513 (e.g., as application layer functionality of the UE) may be collocated (e.g., in a switch box that has TSN connectivity) with the RG 512. The RG 512 comprising the PLC 513 or connected to the PLC 513 is also referred to as PLC-UE 512. The PLC-UE 512 may be connected to the wireline connection 506 comprising an existing TSN infrastructure in the TSN domain 500 (e.g., instead of the RAN 710), and still maintaining all 3GPP-specific security features and yet eliminating the load on the radio resources caused by the PDU session 702.

A connectivity option for TSN (e.g., labeled “wireline TSN” or “TSN-UE”) is offered to the UE 513. Herein, the UE 513 may be an application layer (e.g., comprising the PLC) of the UE 513 or the RG 512. Alternatively or in addition, the UE 513 may be as a separate node connected to the RG 512.

When the UE 513 is connected to the TSN domain 500 (i.e., to the TSN infrastructure) via the RG-TT 100 instead of to the RAN 710, the connectivity option for TSN may be sent to the UE 513 or the RG 512. Alternatively or in addition, the connectivity option for TSN may be applied at a PDU Session Establishment procedure triggered by the UE 513.

The UE 513 (or the RG 512) and UPF 522 are enhanced with a RG-TT function embodying the device 100 (or performing the method 300) and with a GW-TT function embodying the device 200 (or performing the method 400), respectively. Each of the RG-TT 100 and the GW-TT 200 may implement the methods 300 and 400, respectively, on how 3GPP-specific QoS parameters (e.g., for URLLC) are translated to TSN attributes, and vice versa.

This connection of the UE 513 or the RG 512 via the wireline connection 506 in the TSN domain 500, i.e., as a TSN network, is transparent to any sensor, actuators or PLC using services of the 5GS 700, meaning that it appears as a regular 5G connection.

The first device aspect of the technique at the UE side comprises an entity RG-TT 100 at UE side 512 or 513. The function of the RG-TT entity is to translate (i.e., convert) an internal (e.g., URLLC) 5G configuration of the PDUs (e.g., URLLC packets) to the TSN attributes of a TSN configuration in the step 302. As to a second device aspect, an entity GW-TT 200 at the UPF 522 is introduced, which converts the internal (e.g., URLLC) configurations for PDUs (e.g., URLLC packets) to the TSN attributes of the TSN configuration.

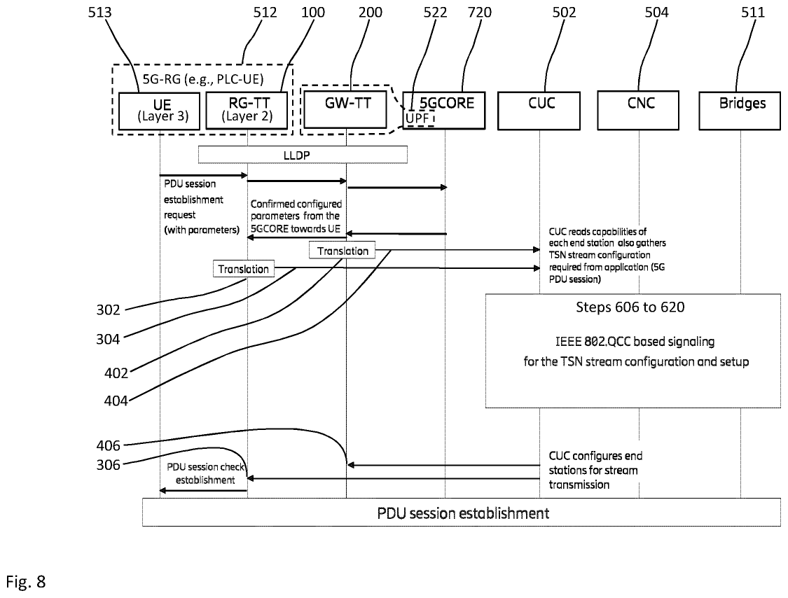

The method 300 performed by the RG-TT 100 may comprise or initiate a method of configuring the one or more TSN streams 510 between the RG-TT 100 and the GW-TT 200. FIG. 8 shows a sequence flow for the TSN configuration, which may be implemented independently or as an extension of the embodiment of the method 300 and/or 400 described with reference to FIG. 6.

At PDU session establishment between UE 513 or RG 512 (i.e., at the RG-TT 100) and the UPF 522 (i.e., at the GW-TT 200), the UE 513 or RG 512 signals the connectivity option “wireline TSN” or “TSN-UE” to the UPF 522. When the CN 720 (e.g., a 5G CN or “5GCORE”) confirms support for that option, both the RG-TT 100 and the GW-TT 200 are configured to enable respective TSN streams 510 for transmission of the PDUs (i.e., data of the PDU session 702) between the RG-TT 100 and GW-TT 200.

The TSN configuration may be applied to the wireline connection 506 via the CUC entity 502 (also: CUC function), which in turn sets up one or more TSN streams 510 in the wireline connection 506 of the TSN domain 500 (i.e., wired TSN network) for the PDU session 702, e.g., for at least one of its including QoS flows 704.

In a variant of any embodiment, the wired UE 513 or RG 512 (i.e., at the RG-TT 100) sends a requests for (e.g., regular) establishment of the PDU session 702 to the CN 720 (e.g., the 5GCORE). The CN 720 determines based on information as to a network topology (e.g., a result of the LLDP) of the wireline connection 506 that the UE 513 or RG 512 is connected via a wired TSN network and thus triggers configuration of the RG 512 and/or the RG-TT 100 as well as the UPF 522 and/or the GW-TT 200 so that at least one or each of the RG-TT 100 and the GW-TT 200 can establish the TSN connection according to the method 300 and 400, respectively, by translating the one or more QoS parameters received from or confirmed by the CN (e.g., the AMF 722 or the UPF 522) and sending the one or more TSN attributes resulting from the translation.

A sequence flow of a more detailed embodiment of the method 300 and/or the method 400 is schematically shown in FIG. 8. This embodiment of the method 300 and/or the method 400 comprises setting-up (i.e., stablishing) the PDU session 702 with the connectivity option (e.g., “wireline TSN” or “TSN-UE”). The method 300 and/or the method 400 may comprise at least one of the below further setup steps, optionally in combination with at least one of the afore-mentioned setup steps.

A first further setup step comprises one or each of the RG-TT 100 and the GW-TT 200 discovering each other, e.g., utilizing layer 2 signaling protocol such as Link Layer Discovery Protocol (LLDP).

A second further setup step comprises the UE 513 or the RG 512 initiating or sending a request for establishing the PDU session 702 (i.e., a PDU session establishment request). The request is indicative of the QoS parameters, e.g., required parameters as defined in the 3GPP document TS 24.501, version 17.1.0.

Optionally, the request is sent in response to receiving or discovering the connectivity option (e.g., “wireline TSN” or “TSN-UE”). In a first variant, the request may be sent from the UE 513 or the RG 512 to the RG-TT 100. In a second variant, the request may be sent from the UE 513 or the RG 512, transparently via RG-TT 100 and GW-TT 200, to the CN 720 (e.g., a 5G CN), e.g., according to the third further setup step.

A third further setup step comprises the RG-TT 100 forwarding the request to the GW-TT 200, which is further forwarded to CN 720 (e.g., a 5G Core Network), optionally to the AMF 722.

A fourth further setup step comprises the CN 720 (e.g., the AMF 722) confirming the PDU session establishment parameters as the QoS parameters. Alternatively or in addition, responsive to determining that the PDU session 702 is through the wireline connection 506 (i.e., via wired TSN), the CN 720 (e.g., the UPF 522) provides an acknowledgement (e.g., as to the establishment of the PDU session 702, the QoS parameters, and/or the PDU session 702 over the wireline connection 506) to the GW-TT 200. The acknowledgement is sent (e.g., forwarded by the GW-TT 200 through the wireline connection 506) also to the RG-TT 100. The acknowledgement may be sent along with an acknowledge of the QoS parameters for the PDU session 702, e.g., as defined in the 3GPP document TS 24.501, version 17.1.0. In the fourth further setup step, necessary parameters for the RG-TT 100 and/or the GW-TT 200 to setup the TSN connection (i.e., the wireline connection 506 in the configured TSN domain 500) according to the methods 300 and 400, respectively, are provides as well. For example, QoS related parameters are provided.

In a variant, the CN 720 confirms the establishment of the PDU session 702 to the UE 513 or the RG 512 by sending directly to the UE 513 or the RG 512 a confirmation message indicative of the establishment of the PDU session 702. The confirmation message is stopped at least at one of the GW-TT 200 and the RG-TT 100 until (e.g., and not forwarded to the UE 513 or the RG 512 until) the TSN connection between GW-TT 200 and the RG-TT 200 is set up, i.e., the QoS parameters are translated and sent to the CUC entity 502 according to the methods 300 and 400, respectively (briefly referred to as TSN setup or TSN stream setup or TSN connection setup).

At least one or each of the GW-TT 200 and the RG-TT 100 derives the (e.g., required) QoS parameters itself from the request for establishing the PDU session 702 and/or from the confirmation messages, for TSN setup.

A fifth further setup step comprises the RG-TT 100 and/or the GW-TT 200 performing the translation 302 and 402, respectively, of the QoS parameters of the PDU session 702 (e.g., QoS rules and other relevant parameters) to the TSN attributes for the TSN configuration (e.g., TSN stream configuration parameters).

The TSN attributes are sent (i.e., communicated) to TSN CUC entity 502 according to the steps 304 and 404, respectively. The TSN attributes may be required for the TSN stream setup.

In a variant, the translation 302 and 402 of the QoS parameters (i.e., QoS information and/or rules) of the PDU session 702 to the CUC entity 502 for the TSN configuration may be based on inversely or reversely taking into account a TSN translation rules from TSN to the PDU session 702 and/or the QoS flow, e.g., defined in 3GPP document TS 23.501, section 5.28.4 and/or QoS mapping tables.

A sixth further setup step comprises the CUC entity 502 generating a request to the CNC entity 504 based on the TSN attributes as the TSN stream listener and talker requirements from the RG-TT 100 and/or the GW-TT 200.

A seventh further setup step comprises the CNC entity 504 performing a computation and configuration of the one or more TSN streams 510 (e.g., based on the IEEE 802.1Qcc standard procedures) and provide the TSN configuration information of the RG-TT 100 and the GW-TT via the CUC entity 502.

An eighth further setup step comprises the CUC entity 502 sending an acknowledge message (also: confirmation message) to the RG-TT 200. The acknowledge message acknowledges the TSN configuration (e.g., setup configuration parameters for the one or more TSN streams 510). Alternatively or in addition, the acknowledge message may be indicative of whether the TSN configuration (e.g., the TSN stream configuration) was successful or not based on the (e.g., required) QoS parameters or the TSN attributes.

An ninth further setup step comprises the UE 513 or the RG 512 initiating the PDU session packets over particular TSN stream (i.e., the sending and/or receiving of the PDUs), e.g., in response to the RG-TT 100 indicating to the UE 513 or the RG 512 that the one or more TSN streams 510 for the (e.g., required or requested) PDU session 702 have been successfully established (i.e., an establishment procedure was successful).

If one or more radio devices 716 (i.e., one or more further UEs functioning as wireless UEs), which may be transmitting and/or receiving the PDUs, are wirelessly connected to the RAN 710 in the same radio communication system 700 (e.g., the same 5GS) and/or to the same UPF, at least one of the QoS parameters (e.g., a Packet Delay Budget) may be adjusted or determined taking into account a first part of the at least one QoS parameter (e.g., a first part of the Packet Delay Budget) consumed already by wireless connection through the RAN 710, when providing QoS parameters for the translation 302 or 402 of the QoS parameters to TSN attributes and/or when sending 304 or 404 the TSN attributes to the CUC entity 502 for the TSN configuration.

Alternatively or in addition, at least some of the further UEs 716 (which may be referred to as wireless UE-L1) may be wirelessly connected to the RG 512.

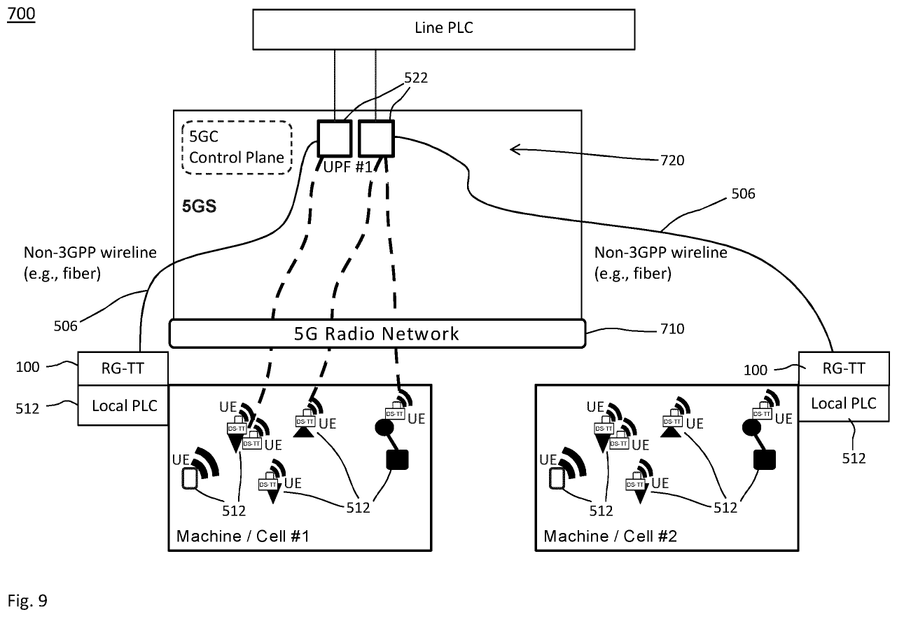

FIG. 9 schematically illustrates an embodiment of a radio communications system 700 comprising at least one cell. Each cell may comprise or correspond to a machine or a production unit. The plurality of further UEs 716 (i.e., the wireless UEs) in each cell are in wireless connection through the RAN 710 to the CN 720. The further UEs 716 may function as sensors and actuators of the respective machine or production unit. Each cell comprises a RG 512 comprising, or connected to, a wireline UE functioning as a local PLC (also referred to as PLC-UE) that reads the sensors and controls the actuators, e.g., in operating the respective machine or production unit.

Each of the wireline UEs 513 or RG 512 is connected to the wireline connection 506 by means of an embodiment of the RG-TT 100.

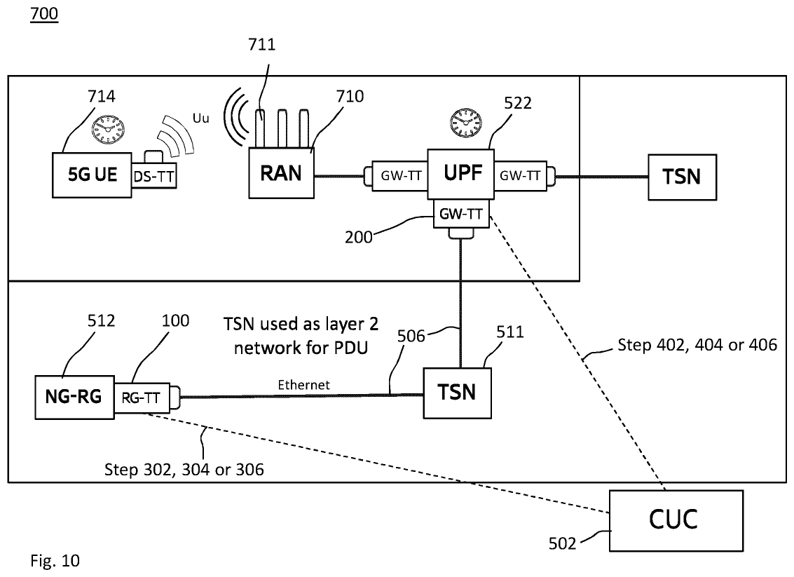

FIG. 10 schematically illustrates an embodiment of radio communications system. At least one or each of the GW-TT 100 and the RG-TT 200 provides one or more of the following TSN attributes to the CUC 502. A first TSN attribute is indicative of one or more end station interfaces, e.g. a number of the ports and/or a MAC address of each port. A second TSN attribute is indicative of interface capabilities, e.g., the capabilities defined in IEEE 802.1Q, IEEE 802.1Qbv, and/or IEEE 802.1AS.

A third TSN attribute is indicative of a traffic specification on the wireline connection 506, e.g., a maximum frame size, a maximum number of frames per interval (e.g., the maximum frame per interval or “MaxFramesPerInterval” as defined in IEEE 802.1Qcc in clause 46.2.3.5.2 or the maximum number of frames that the talker 508 can transmit in one interval), and/or (e.g., maximum) size of the end station data. For example, the size of the end station data may be the size of the PDU or service data unit (SDU) transmitted between GW-TT and RG-TT, i.e., in the wireline connection 506 in the PDU session. Alternatively or in addition, the maximum size of the end station data (“MaxFrameSize”) may specify the maximum frame size that the talker 508 will transmit, excluding any overhead for media-specific framing (e.g., preamble, IEEE 802.3 header, Priority/VID tag, CRC, interframe gap). As the talker 508 or bridge 511 determines the amount of bandwidth to reserve on the egress port (e.g., the interface Y4), it will calculate the media-specific framing overhead on that port and add it to the number specified in the MaxFrameSize element.

In a centralized configuration, the method 300 and/or 400 using the CUC entity 502 and/or the configuration and management by the using the CUC entity 502 and the CNC entity 504 may be performed periodically, e.g., according to IEEE 802.1Qcc. The 5G system (i.e., the GW-TT 200 and/or the RG-TT 100) provides the TSN configuration in terms of the TSN attributes according to the methods 300 and 400 based the QoS parameters determined (e.g., periodically) from an application configuration and/or provided (e.g., periodically) by the application layer of the UE 513 or the RG 512.

The RG-TT 100 and the GW-TT 200 receive in a step 306 and a step 406 of the method 300 and the method 400, respectively, the TSN configuration resulting from the sent TSN attributes. For example, one or each of the RG-TT 100 and the GW-TT 200 may perform time-gated queueing of the PDUs according to the TSN configuration received from the CUC entity 502.

As for the TSN domain 500, the PDU session 702 becomes an application. The PDUs (i.e., user payload) are embedded into the data part of the frames (e.g., Ethernet frames) of the TSN streams 510 on the wireline connection 506.

In any embodiment, the one or more QoS parameters may be indicative of the PDU session 702 and/or may be indicative of the at least one QoS flow 704. The one or more QoS parameters are translated to the one or more TSN attributes (e.g., comprising parameters of the TSN stream 510) according to the step 302 or 402.

The translation 302 or 402 may be based on a Packet Delay Budget (PDB) and/or QoS Class Identifiers (QCI) defined for the particular PDU session 702 or QoS flow 704. An application configuration, e.g., from the UE 513 or the application layer of the RG 512 may be indicative of a limit on delay and/or a limit on jitter. Such limits may be provided in the steps 304 and 404 by the devices 100 and/or 200 (i.e., the translator functions) to CUC entity 502 for configuring the TSN domain 500 comprising the wireline communication.

Alternatively or in addition, any embodiment of the method 300 (e.g., a procedure) may allow the UE 513 (e.g., the application layer of the RG 512) or the RG 512 to connect via the wireline connection 506 (e.g., a wired TSN network) to the UPF 522 in the radio communications system 700 (e.g., a 5G system, 5GS), e.g., as a scenario shown in FIG. 10. Embodiments of the technique can allow both a wireless device 714 and a wireline device as the RG 512 or UE 513 to be connected within the 5G system 700 and/or to use 5G features such as guarantee latency, reliability, security, and/or authentication. In the radio communications system 700, the wireless access by means of base stations 711 of the RAN 710 to the UPF 522 coexists with the wireline connection 506 to the UPF 522.

The methods 300 and 400 may be implemented to extend 5G wireline communication 506 to enable time-sensitive communication (i.e., TSN) of the PDUs in the 5G system 700 over the wireline connection 506 as a TSN infrastructure (i.e., a TSN domain 500).

The devices 100 and 200 performing the methods 300 and 400, respectively, may comprise translation functionalities, e.g., layers or nodes, for a Resident Gateway TSN Translator (RG-TT) and a Gateway TSN Translator (GW-TT), respectively, which translate (i.e., convert) according to the steps 302 and 402, respectively, one or more QoS parameters of the PDU session 702 to one or more TSN attributes for the TSN configuration. The TSN attributes may comprise TSN capabilities required to transport the PDU (e.g., 5G packets) over the TSN infrastructure (i.e., a TSN domain 500). The QoS parameters may comprise an ultra-reliable low-latency (URLLC) configuration.

The RG-TT 100 and the GW-TT 200 may hide the existence of the TSN domain 500 from the UE 513 or the RG 512 and the UPF 522, respectively.

Any embodiment of the methods 300 and 400 may further comprise steps for reference time synchronization, as required for the TSN domain 500.

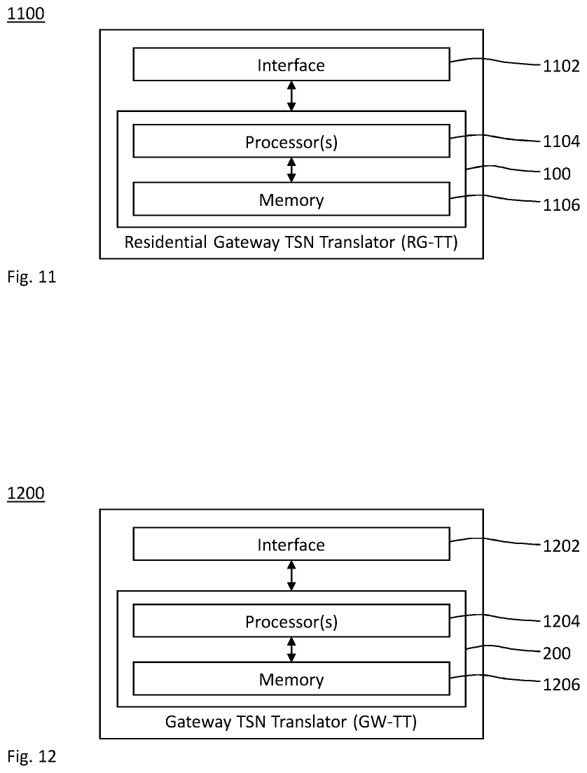

FIG. 11 shows a schematic block diagram for an embodiment of the device 100. The device 100 comprises processing circuitry, e.g., one or more processors 1104 for performing the method 300 and memory 1106 coupled to the processors 1104. For example, the memory 1106 may be encoded with instructions that implement at least one of the modules 102 and 104.

The one or more processors 1104 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 100, such as the memory 1106, TSN translator functionality. For example, the one or more processors 1104 may execute instructions stored in the memory 1106. Such functionality may include providing various features and steps discussed herein, including any of the benefits disclosed herein. The expression “the device being operative to perform an action” may denote the device 100 being configured to perform the action.

As schematically illustrated in FIG. 11, the device 100 may be embodied by a residential gateway TSN translator (RG-TT) 1100, e.g., functioning as a TSN talker and/or TSN listener on the wireline connection on behalf of the UE or the RG. The RG-TT 1100 comprises at least one wireline interface 1102 coupled to the device 100 for the wireline connection with the CN or the UPF and for connecting with the UE or RG.

FIG. 12 shows a schematic block diagram for an embodiment of the device 200. The device 200 comprises processing circuitry, e.g., one or more processors 1204 for performing the method 400 and memory 1206 coupled to the processors 1204. For example, the memory 1206 may be encoded with instructions that implement at least one of the modules 202 and 204.

The one or more processors 1204 may be a combination of one or more of a microprocessor, controller, microcontroller, central processing unit, digital signal processor, application specific integrated circuit, field programmable gate array, or any other suitable computing device, resource, or combination of hardware, microcode and/or encoded logic operable to provide, either alone or in conjunction with other components of the device 200, such as the memory 1206, TSN translator functionality. For example, the one or more processors 1204 may execute instructions stored in the memory 1206. Such functionality may include providing various features and steps discussed herein, including any of the benefits disclosed herein. The expression “the device being operative to perform an action” may denote the device 200 being configured to perform the action.

As schematically illustrated in FIG. 12, the device 200 may be embodied by a (e.g., network) gateway TSN translator (GW-TT) 1200, e.g., functioning as a TSN talker and/or TSN listener on the wireline connection on behalf of the CN or the UPF. The GW-TT 1200 comprises at least one wireline interface 1202 coupled to the device 200 for the wireline connection with the UE or the RG and for connecting with the CN or UPF.

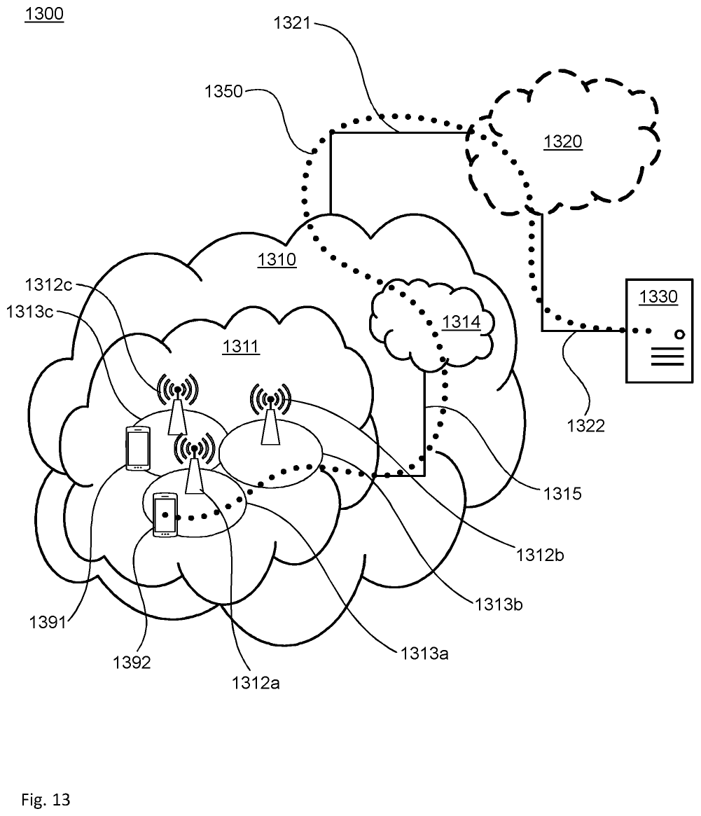

With reference to FIG. 13, in accordance with an embodiment, a communication system 1300 includes a telecommunication network 1310 (as an example of the radio communications system 700), such as a 3GPP-type cellular network, which comprises an access network 1311 (as an example of the RAN 710), such as a radio access network, and a core network 1314 (as an example of the CN 720). The access network 1311 comprises a plurality of base stations 1312a, 1312b, 1312c as examples of the base station 711, such as NBs, eNBs, gNBs or other types of wireless access points, each defining a corresponding coverage area 1313a, 1313b, 1313c. Each base station 1312a, 1312b, 1312c is connectable to the core network 1314 over a wired or wireless connection 1315. A first user equipment (UE) 1391 located in coverage area 1313c is configured to wirelessly connect to, or be paged by, the corresponding base station 1312c. A second UE 1392 in coverage area 1313a is wirelessly connectable to the corresponding base station 1312a. While a plurality of UEs 1391, 1392 are illustrated in this example, the disclosed embodiments are equally applicable to a situation where a sole UE is in the coverage area or where a sole UE is connecting to the corresponding base station 1312.

Any of the base stations 1312 may be replaced by the UPF 522 and the GW-TT 200 in the wireline connection 506 with one or more of the UEs. Any of the UEs 1391, 1392 may be replaced by the UE 513, the RG 512 and the RG-TT 100 in the wireline connection 506 with the CN 720 or the UPF 522.

The telecommunication network 1310 is itself connected to a host computer 1330, which may be embodied in the hardware and/or software of a standalone server, a cloud-implemented server, a distributed server or as processing resources in a server farm. The host computer 1330 may be under the ownership or control of a service provider, or may be operated by the service provider or on behalf of the service provider. The connections 1321, 1322 between the telecommunication network 1310 and the host computer 1330 may extend directly from the core network 1314 to the host computer 1330 or may go via an optional intermediate network 1320. The intermediate network 1320 may be one of, or a combination of more than one of, a public, private or hosted network; the intermediate network 1320, if any, may be a backbone network or the Internet; in particular, the intermediate network 1320 may comprise two or more sub-networks (not shown).

The communication system 1300 of FIG. 13 as a whole enables connectivity between one of the connected UEs 1391, 1392 and the host computer 1330. The connectivity may be described as an over-the-top (OTT) connection 1350. The host computer 1330 and the connected UEs 1391, 1392 are configured to communicate data and/or signaling via the OTT connection 1350, using the access network 1311, the core network 1314, any intermediate network 1320 and possible further infrastructure (not shown) as intermediaries. The OTT connection 1350 may be transparent in the sense that the participating communication devices through which the OTT connection 1350 passes are unaware of routing of uplink and downlink communications. For example, a base station 1312 need not be informed about the past routing of an incoming downlink communication with data originating from a host computer 1330 to be forwarded (e.g., handed over) to a connected UE 1391. Similarly, the base station 1312 need not be aware of the future routing of an outgoing uplink communication originating from the UE 1391 towards the host computer 1330.

By virtue of the method 100 being performed at any one of the UEs 1391 or 1392 comprising the RG 512 and the RG-TT 100 and/or by virtue of the method 200 being performed by a UPF of the CN and a GW-TT 200, the performance or range of the OTT connection 1350 can be improved, e.g., in terms of increased throughput and/or reduced latency. More specifically, the host computer 1330 may indicate to the CN the QoS parameter of the traffic, which are translated in the step 302 and/or in the step 402.

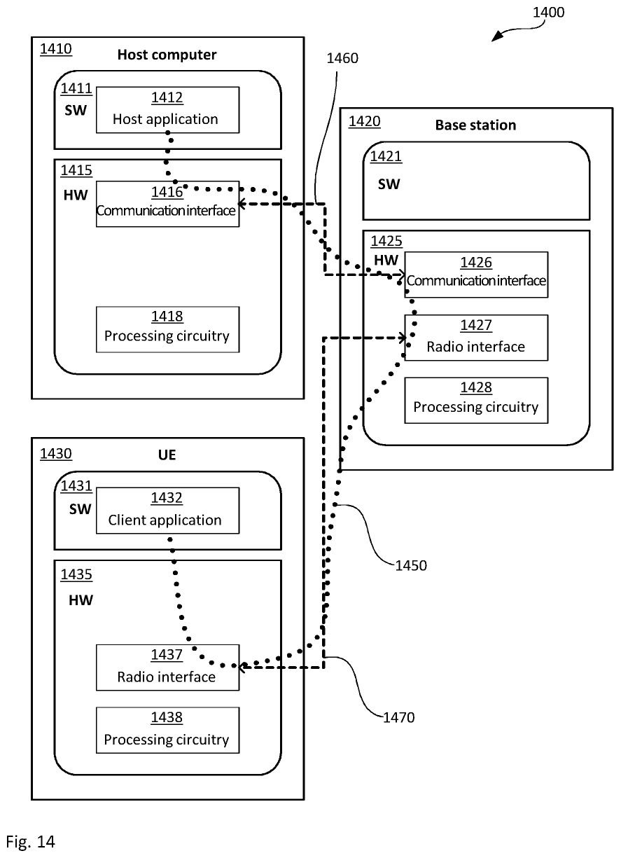

Example implementations, in accordance with an embodiment of the UE, base station and host computer discussed in the preceding paragraphs, will now be described with reference to FIG. 14. In a communication system 1400, a host computer 1410 comprises hardware 1415 including a communication interface 1416 configured to set up and maintain a wired or wireless connection with an interface of a different communication device of the communication system 1400. The host computer 1410 further comprises processing circuitry 1418, which may have storage and/or processing capabilities. In particular, the processing circuitry 1418 may comprise one or more programmable processors, application-specific integrated circuits, field programmable gate arrays or combinations of these (not shown) adapted to execute instructions. The host computer 1410 further comprises software 1411, which is stored in or accessible by the host computer 1410 and executable by the processing circuitry 1418. The software 1411 includes a host application 1412. The host application 1412 may be operable to provide a service to a remote user, such as a UE 1430 connecting via an OTT connection 1450 terminating at the UE 1430 and the host computer 1410. In providing the service to the remote user, the host application 1412 may provide user data, which is transmitted using the OTT connection 1450. The user data may depend on the location of the UE 1430. The user data may comprise auxiliary information or precision advertisements (also: ads) delivered to the UE 1430. The location may be reported by the UE 1430 to the host computer, e.g., using the OTT connection 1450, and/or by the base station 1420, e.g., using a connection 1460.

The communication system 1400 further includes a base station 1420 provided in a telecommunication system and comprising hardware 1425 enabling it to communicate with the host computer 1410 and with the UE 1430. The hardware 1425 may include a communication interface 1426 for setting up and maintaining a wired or wireless connection with an interface of a different communication device of the communication system 1400, as well as a radio interface 1427 for setting up and maintaining at least a wireless connection 1470 with a UE 1430 located in a coverage area (not shown in FIG. 14) served by the base station 1420. The communication interface 1426 may be configured to facilitate a connection 1460 to the host computer 1410. The connection 1460 may be direct, or it may pass through a core network (not shown in FIG. 14) of the telecommunication system and/or through one or more intermediate networks outside the telecommunication system. In the embodiment shown, the hardware 1425 of the base station 1420 further includes processing circuitry 1428, which may comprise one or more programmable processors, application-specific integrated circuits, field programmable gate arrays or combinations of these (not shown) adapted to execute instructions. The base station 1420 further has software 1421 stored internally or accessible via an external connection.

The communication system 1400 further includes the UE 1430 already referred to. Its hardware 1435 may include a radio interface 1437 configured to set up and maintain a wireless connection 1470 with a base station serving a coverage area in which the UE 1430 is currently located. The hardware 1435 of the UE 1430 further includes processing circuitry 1438, which may comprise one or more programmable processors, application-specific integrated circuits, field programmable gate arrays or combinations of these (not shown) adapted to execute instructions. The UE 1430 further comprises software 1431, which is stored in or accessible by the UE 1430 and executable by the processing circuitry 1438. The software 1431 includes a client application 1432. The client application 1432 may be operable to provide a service to a human or non-human user via the UE 1430, with the support of the host computer 1410. In the host computer 1410, an executing host application 1412 may communicate with the executing client application 1432 via the OTT connection 1450 terminating at the UE 1430 and the host computer 1410. In providing the service to the user, the client application 1432 may receive request data from the host application 1412 and provide user data in response to the request data. The OTT connection 1450 may transfer both the request data and the user data. The client application 1432 may interact with the user to generate the user data that it provides.

It is noted that the host computer 1410, base station 1420 and UE 1430 illustrated in FIG. 14 may be identical to the host computer 1330, one of the base stations 1312a, 1312b, 1312c and one of the UEs 1391, 1392 of FIG. 13, respectively. This is to say, the inner workings of these entities may be as shown in FIG. 14, and, independently, the surrounding network topology may be that of FIG. 13.

In FIG. 14, the OTT connection 1450 has been drawn abstractly to illustrate the communication between the host computer 1410 and the UE 1430 via the base station 1420, without explicit reference to any intermediary devices and the precise routing of messages via these devices. Network infrastructure may determine the routing, which it may be configured to hide from the UE 1430 or from the service provider operating the host computer 1410, or both. While the OTT connection 1450 is active, the network infrastructure may further take decisions by which it dynamically changes the routing (e.g., on the basis of load balancing consideration or reconfiguration of the network).

The wireless connection 1470 between the UE 1430 and the base station 1420 is in accordance with the teachings of the embodiments described throughout this disclosure. One or more of the various embodiments improve the performance of OTT services provided to the UE 1430 using the OTT connection 1450, in which the wireless connection 1470 forms the last segment. More precisely, the teachings of these embodiments may reduce the latency and improve the data rate and thereby provide benefits such as better responsiveness and improved QoS.

A measurement procedure may be provided for the purpose of monitoring data rate, latency, QoS and other factors on which the one or more embodiments improve. There may further be an optional network functionality for reconfiguring the OTT connection 1450 between the host computer 1410 and UE 1430, in response to variations in the measurement results. The measurement procedure and/or the network functionality for reconfiguring the OTT connection 1450 may be implemented in the software 1411 of the host computer 1410 or in the software 1431 of the UE 1430, or both. In embodiments, sensors (not shown) may be deployed in or in association with communication devices through which the OTT connection 1450 passes; the sensors may participate in the measurement procedure by supplying values of the monitored quantities exemplified above, or supplying values of other physical quantities from which software 1411, 1431 may compute or estimate the monitored quantities. The reconfiguring of the OTT connection 1450 may include message format, retransmission settings, preferred routing etc.; the reconfiguring need not affect the base station 1420, and it may be unknown or imperceptible to the base station 1420. Such procedures and functionalities may be known and practiced in the art. In certain embodiments, measurements may involve proprietary UE signaling facilitating the host computer's 1410 measurements of throughput, propagation times, latency and the like. The measurements may be implemented in that the software 1411, 1431 causes messages to be transmitted, in particular empty or “dummy” messages, using the OTT connection 1450 while it monitors propagation times, errors etc.

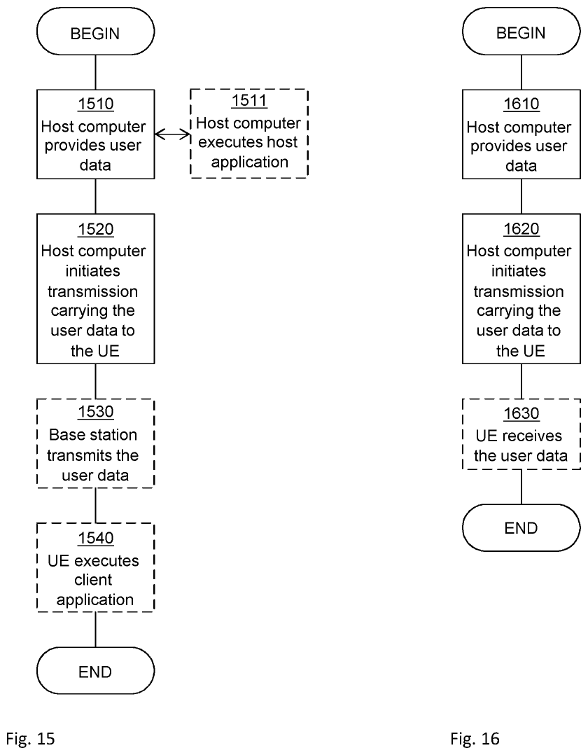

FIG. 15 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 15 will be included in this paragraph. In a first step 1510 of the method, the host computer provides user data. In an optional substep 1511 of the first step 1510, the host computer provides the user data by executing a host application. In a second step 1520, the host computer initiates a transmission carrying the user data to the UE. In an optional third step 1530, the base station transmits to the UE the user data which was carried in the transmission that the host computer initiated, in accordance with the teachings of the embodiments described throughout this disclosure. In an optional fourth step 1540, the UE executes a client application associated with the host application executed by the host computer.

FIG. 16 is a flowchart illustrating a method implemented in a communication system, in accordance with one embodiment. The communication system includes a host computer, a base station and a UE which may be those described with reference to FIGS. 13 and 14. For simplicity of the present disclosure, only drawing references to FIG. 16 will be included in this paragraph. In a first step 1610 of the method, the host computer provides user data. In an optional substep (not shown) the host computer provides the user data by executing a host application. In a second step 1620, the host computer initiates a transmission carrying the user data to the UE. The transmission may pass via the base station, in accordance with the teachings of the embodiments described throughout this disclosure. In an optional third step 1630, the UE receives the user data carried in the transmission.

As has become apparent from the above description of exemplary embodiments, at least some embodiments of the technique allow (e.g., wirelessly) UE-connected sensors, (e.g., wirelessly) UE-connected actuators and wireline UE-connected PLCs to benefit from all 5G services such as security or authenticity that a 5GS provides, irrespective if the UE uses a wireless (i.e., radio) link or a wireline connection in a TSN domain to connect to the UPF.

In same or further embodiments, a UE functionality (e.g., layer 3 and/or the application layer) registered at the 5GS is offered the choice to connect the UE functionality to the UPF either via a RAN or via a wireline connection (as a TSN wired NW) instead. Both connection options can have the same QoS parameters (i.e., QoS characteristics), authentication methods, and/or encryption procedures.

Many advantages of the present invention will be fully understood from the foregoing description, and it will be apparent that various changes may be made in the form, construction and arrangement of the units and devices without departing from the scope of the invention and/or without sacrificing all of its advantages. Since the invention can be varied in many ways, it will be recognized that the invention should be limited only by the scope of the following claims.

1.-43. (canceled)

44. A method of communicating protocol data units (PDUs) of a PDU session through a wireline connection between a residential gateway (RG) and a user plane function (UPF) of a core network (CN) of a radio communications system, wherein the PDU session extends between the UPF and the RG registered as a user equipment (UE) at the CN, the method comprising:
translating one or more quality of service (QoS) parameters associated with at least one QoS flow of the PDU session to one or more time-sensitive networking (TSN) attributes; and
sending the one or more TSN attributes to an entity for centralized user configuration (CUC) of a TSN domain comprising the wireline connection between the RG and the UPF.

45. The method of claim 44, wherein the method is performed by the RG or a RG TSN translator (RG-TT) connected to at least one of the RG and the UE, wherein the RG-TT connects the UE to a link layer of the wireline connection and/or a link layer of the TSN domain.

46. The method of claim 45, further comprising sending a TSN announcing message from the RG-TT to the UE, responsive to connecting the UE with the RG-TT, wherein the TSN attributes are sent to the CUC entity responsive to a confirmation message received from the UE in response to the TSN announcing message.

47. The method of claim 44, further comprising:
receiving PDUs from the UE; and
sending the PDUs from the UE in frames of the link layer of the wireline connection and/or in TSN streams of the TSN domain between the RG and the CN.

48. The method of claim 47, further comprising receiving a TSN configuration from the CUC entity responsive to the sending of the one or more TSN attributes, wherein the sending of the PDUs comprises mapping, according to the received TSN configuration, the PDUs from the UE into the frames and/or into the TSN streams.

49. The method of claim 44, further comprising:
extracting the PDUs for the UE from frames of the link layer of the wireline connection and/or from the TSN streams of the TSN domain between the RG and the CN; and
sending the extracted PDUs to the UE.

50. The method of claim 44, wherein the PDUs of the PDU session comprise at least one of PDUs of a user plane of the UE and PDUs of a control plane of the UE, and wherein the one or more PDUs of the control plane of the UE comprise radio resource control (RRC) signaling.

51. The method of claim 44, wherein the method is triggered by establishing the PDU session, and/or wherein the one or more QoS parameters are determined based on at least one of a request for establishing the PDU session from the RG and a confirmation of the QoS parameters from the UPF or the CN.

52. The method of claim 44, wherein the one or more TSN attributes are indicative of requirements for TSN streams in which the PDUs are communicated through the wireline connection in the TSN domain, and/or wherein the one or more QoS parameters are indicative of an ultra-reliable low-latency configuration (URLLC) configuration, of the respective QoS flow.

53. The method of claim 44, wherein the one or more QoS parameters are indicative or based on at least one of:
a Packet Delay Budget (PDB);
a QoS Class Identifiers (QCI);
a limit on a delay of the PDUs; and
a limit on a jitter of the PDUs.

54. The method of claim 44, wherein one or more QoS parameters are provided by or based on a configuration of an application layer of the UE or the RG.

55. The method of claim 44, wherein the radio communications system comprises a radio access network (RAN), which provides radio access to the CN for a plurality of further UEs, and wherein the QoS parameters comprise the PDB that comprises a first part for the RAN and a second part for the wireline communication, the translating being based on the second part.

56. The method of claim 44, further comprising retaining a confirmation message indicative of the establishment of the PDU session from the CN until the TSN configuration is received from the CUC entity responsive to the sending of the one or more TSN attributes.

57. The method of claim 44, wherein the one or more QoS parameters are indicative of one or more rules for generating the TSN configuration at the CUC entity.

58. The method of claim 44, further comprising:
receiving PDUs from the UPF; and
sending the PDUs from the UPF in frames of the link layer of the wireline connection and/or in TSN streams of the TSN domain between the RG and the CN.

59. The method of claim 44, further comprising:
extracting the PDUs for the UPF from frames of the link layer of the wireline connection and/or from the TSN streams of the TSN domain between the RG and the CN; and
sending the extracted PDUs to the UPF.

60. A residential gateway TSN translator (RG-TT) for communicating protocol data units (PDUs) of a PDU session through a wireline connection between a residential gateway (RG) and a user plane function (UPF) of a core network (CN) of a radio communications system, wherein the PDU session extends between the UPF and the RG registered as a user equipment (UE) at the CN, the RG-TT comprising memory operable to store instructions and processing circuitry operable to execute the instructions, such that the RG-TT is operable to:
translate one or more QoS parameters associated with at least one QoS flow of the PDU session to one or more time-sensitive networking (TSN) attributes; and
send the one or more TSN attributes to an entity for centralized user configuration (CUC) of a TSN domain comprising the wireline connection between the RG and the UPF.

61. A gateway TSN translator (GW-TT) for communicating protocol data units (PDUs) of a PDU session through a wireline connection between a residential gateway (RG) and a user plane function (UPF) of a core network (CN) of a radio communications system, wherein the PDU session extends between the UPF and the RG registered as a user equipment (UE) at the CN, the GW-TT comprising memory operable to store instructions and processing circuitry operable to execute the instructions, such that the GW-TT is operable to:
translate one or more QoS parameters associated with at least one QoS flow of the PDU session to one or more time-sensitive networking (TSN) attributes; and
send the one or more TSN attributes to an entity for centralized user configuration (CUC) of a TSN domain comprising the wireline connection between the RG and the UPF.
